(19) United States
(12) Patent Application Publication
(10) Pub. No.: US 2026/0133640 A1
(43) Pub. Date: May 14, 2026

(54) METHOD AND DEVICE FOR DETECTING GESTURE USING ULTRAWIDE BAND COMMUNICATION SIGNAL

(71) Applicant: SAMSUNG ELECTRONICS CO., LTD., Suwon-si, Gyeonggi-do (KR)

(72) Inventors: Hyunseob OH, Suwon-si (KR); Sagnik BHATTACHARYA, Suwon-si (KR); Seungbeom SEO, Suwon-si (KR)

(21) Appl. No.: 19/121,762

(22) PCT Filed: Oct. 17, 2022
(86) PCT No.: PCT/KR2022/015760

§ 371 Date: Apr. 16, 2025

(51) Int. Cl. G06F 3/01; G06F 3/0346; G06F 3/038; G06N 3/0464

(52) U.S. Cl. CPC G06F 3/017; G06F 3/011; G06F 3/0346; G06F 3/0383; G06N 3/0464; G06F 2203/0384

(57) ABSTRACT

Disclosed is a method for an electronic device to use a UWB signal to detect a gesture. The method disclosed herein may comprise the steps of: preprocessing UWB data and IMU sensor data for a preset gesture period; using a classifier, trained in advance, to generate gesture prediction data on the basis of the preprocessed UWB data and IMU data; and detecting a gesture on the basis of the gesture prediction data. Here, the UWB data may include at least one of ranging result data, AoA data, or CIR data acquired through UWB ranging between the electronic device and at least one nearby device.

### TECHNICAL FIELD

The disclosure relates to a method and a device for detecting a gesture or a motion of a user by using a UWB signal.

### BACKGROUND ART

The Internet, which is a human centered connectivity network where humans generate and consume information, is now evolving to the Internet of things (IoT) where distributed entities, such as things, exchange and process information. The Internet of everything (IoE), which is a combination of the IoT technology and the big data processing technology through a connection with a cloud server, etc. has emerged. As technology elements, such as “sensing technology”, “wired/wireless communication and network infrastructure”, “service interface technology”, and “security technology” have been demanded for IoT implementation. Recently, a sensor network, a machine-to-machine (M2M) communication, machine type communication (MTC), and so forth have been researched.

Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

### DETAILED DESCRIPTION OF THE INVENTION

### Technical Problem

The disclosure provides a method for detecting a gesture or a motion of a user by using UWB data and sensor data.

### Technical Solution

According to various embodiments of the disclosure, a method for an electronic device may include preprocessing ultrawideband (UWB) data and inertial measurement unit (IMU) sensor data for a pre-specified gesture period, generate gesture prediction data, based on the preprocessed UWB data and IMU data, by using a pretrained classifier, and detecting a gesture, based on the gesture prediction data, wherein the preprocessing includes filtering the UWB data by using at least one first filter, and filtering the IMU sensor data by using a second filter, and the UWB data includes at least one of ranging result data, angle of arrival (AoA) data, or channel impulse response (CIR) data acquired through UWB ranging between the electronic device and at least one peripheral device.

According to various embodiments of the disclosure, an electronic device may include a transceiver and a controller connected to the transceiver, wherein the controller is configured to preprocess ultrawideband (UWB) data and inertial measurement unit (IMU) sensor data for a pre-specified gesture period, generate gesture prediction data, based on the preprocessed UWB data and IMU data, by using a pretrained classifier, and detect a gesture, based on the gesture prediction data, wherein the controller is further configured to for the preprocessing, filter the UWB data by using at least one first filter, and filter the IMU sensor data by using a second filter, and the UWB data includes at least one of ranging result data, angle of arrival (AoA) data, or channel impulse response (CIR) data acquired through UWB ranging between the electronic device and at least one peripheral device.

### BRIEF DESCRIPTION OF DRAWINGS

FIG. 1 is a block diagram schematically illustrating an electronic device.

FIG. 2A illustrates exemplary architecture of a UWB device according to an embodiment of the disclosure.

FIG. 2B illustrates an exemplary configuration of a framework of a UWB device according to an embodiment of the disclosure.

FIG. 3A illustrates a structure of a UWB MAC frame according to an embodiment of the disclosure.

FIG. 3B illustrates a structure of a UWB PHY packet according to an embodiment of the disclosure.

FIG. 4 illustrates an example of a structure a ranging block and rounds used for UWB ranging according to an embodiment of the disclosure.

FIG. 5 illustrates an SS-TWR ranging procedure according to an embodiment of the disclosure.

FIG. 6 illustrates a DS-TWR ranging procedure according to an embodiment of the disclosure.

FIG. 7 illustrates an example of a body area network (BAN) supporting UWB communication according to an embodiment of the disclosure.

FIG. 8 illustrates an example of arrangement of electronic devices included in a BAN supporting UWB communication according to an embodiment of the disclosure.

FIG. 9 illustrates various examples of a user gesture which can be identified through a BAN supporting UWB communication according to an embodiment of the disclosure.

FIG. 10A illustrates an example of ranging data and AoA data indicating characteristics of a circle gesture according to an embodiment of the disclosure.

FIG. 10B illustrates an example of ranging data and AoA data indicating characteristics of a boxing gesture according to an embodiment of the disclosure.

FIG. 11 illustrates a configuration of an electronic device including a model of classifying a user gesture by using data acquired through UWB ranging and sensing data according to an embodiment of the disclosure.

FIG. 12 illustrates an example of a method for training a model for classifying a gesture, and using the trained model according to an embodiment of the disclosure.

FIG. 13 illustrates another example of a method for training a model for classifying a gesture, and using the trained model according to an embodiment of the disclosure.

FIG. 14 illustrates a filtering operation of a first filter according to an embodiment of the disclosure.

FIG. 15 illustrates a filtering operation of a second filter according to an embodiment of the disclosure.

FIG. 16 illustrates a filtering operation of a third filter according to an embodiment of the disclosure.

FIG. 17 illustrates an operation of a feature extraction unit according to an embodiment of the disclosure.

FIG. 18 illustrates an operation of a classifier according to an embodiment of the disclosure.

FIG. 19 illustrates an operation of a loss function unit according to an embodiment of the disclosure.

FIG. 20 illustrates a method in which an electronic device transfers a gesture detection result to an application, as an input, according to an embodiment of the disclosure.

FIG. 21 illustrates an example of a data information element according to an embodiment of the disclosure.

FIG. 22 illustrates another example of a data information element according to an embodiment of the disclosure.

FIG. 23 is a flowchart illustrating a method for an electronic device according to an embodiment of the disclosure.

FIG. 24 illustrates a structure of an electronic device according to an embodiment of the disclosure.

### MODE FOR CARRYING OUT THE INVENTION

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The instructions which execute on a computer or other programmable data processing apparatus to cause a series of operational steps to be performed on the computer or other programmable data processing apparatus to produce a computer implemented process may provide steps for implementing the functions specified in the flowchart block(s).

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, according to some embodiments, the “unit” may include one or more processors.

As used herein, the term “terminal” or “device” may also be referred to as a mobile station (MS), a user equipment (UE), a user terminal (UT), a wireless terminal, an access terminal (AT), a terminal, a subscriber unit, a subscriber station (SS), a wireless device, a wireless communication device, a wireless transmit/receive unit (WTRU), a mobile node, a mobile, or other terms. Various example of the terminal may include a cellular phone, a smartphone having a wireless communication function, a personal digital assistant (PDA) having a wireless communication function, a wireless modem, a portable computer having a wireless communication function, a photographing device, such as a digital camera, having a wireless communication function, a gaming device having a wireless communication function, a music storage and reproduction home appliance having a wireless communication function, an Internet home appliance capable of wireless Internet access and browsing, and portable units or terminals having integrated combinations of the above functions. Furthermore, the terminal may include a machine to machine (M2M) terminal, and a machine type communication (MTC) terminal/device, but is not limited thereto. In the specification, the terminal may also be referred to as an electronic device or simply as a device.

Hereinafter, the operation principle of the disclosure will be described in detail in conjunction with the accompanying drawings. In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

Hereinafter, embodiments of the disclosure will be described in detail in conjunction with the accompanying drawings. In the following description of embodiments of the disclosure, a communication system using a UWB will be described by way of example, but the embodiments of the disclosure may be applied to other communication systems having similar technical backgrounds or characteristics. Examples of such communication systems may include communication systems Bluetooth or ZigBee. Therefore, based on determinations by those skilled in the art, the embodiments of the disclosure may be applied to other communication systems through some modifications without significantly departing from the scope of the disclosure.

Also, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In general, a wireless sensor network technology is largely divided into a wireless local area network (WLAN) technology and a wireless personal area network (WPAN) technology according to the recognition distance. In this case, the WLAN is a technology based on IEEE 802.11, which enables access to a backbone network within a radius of about 100 m. The WPAN is a technology based on IEEE 802.15, which includes Bluetooth™. ZigBee™, and ultrawideband (UWB) communication. A wireless network in which such a wireless network technology is implemented may include a plurality of electronic devices.

According to definitions by the Federal Communications Commission (FCC), UWB may refer to a wireless communication technology that uses a bandwidth of 500 MHz or more or a bandwidth corresponding to a center frequency of 20% or more. The UWB may also refer a band itself to which UWB communication is applied. The UWB enables secure and accurate ranging between devices. Accordingly, the UWB enables relative position estimation based on the distance between two devices or accurate position estimation of a device based on the distance from fixed devices (the positions of which are known).

Particular terms as used in the following description are merely provided to help understanding pf the disclosure, and other types of terms may be used without departing from the scope of the technical idea of the disclosure.

An “application dedicated file (ADF)” may be, for example, a data structure in an application data structure that may host an application or application specific data.

An “application protocol data unit (APDU)” may be a command and a response used when communicating with the application data structure in a UWB device.

“Application specific data” may be, for example, a file structure having a root level and an application level including UWB controlee information and UWB session data required for a UWB session.

A “controller” may be a ranging device that defines and controls ranging control messages (RCMs) (or control messages). The controller may define and control ranging features by sending the control message.

A “controlee” may be a ranging device using a ranging parameter in the RCM (or control message) received from the controller. The controlee may use the ranging features as configured via the control message from the controller.

Unlike static STS, a “dynamic scrambled timestamp sequence (STS) mode” may be an operation mode in which an STS is not repeated during a ranging session. In this mode, the STS may be managed by the ranging device, and a ranging session key that generates the STS may be managed by a secure component.

An “applet” may be, for example, an applet executed on a secure component including UWB parameters and service data. The applet may be a FiRa applet.

A “ranging device” may be a device capable of performing UWB ranging. In the disclosure, the ranging device may be an enhanced ranging device (ERDEV) defined in IEEE 802.15.4z or a FiRa device. The ranging device may be referred to as a UWB device.

A “UWB-enabled application” may be an application for UWB service. For example, the UWB-enabled application may be an application using a framework API for configuring an OOB connector, a secure service, and/or a UWB service for a UWB session. The “UWB-enabled application” may be abbreviated as an application or a UWB application. The UWB-enabled application may be a FiRa-enabled application.

A “framework” may be a component that provides access to profiles, individual UWB settings and/or notifications. The “framework” may be, for example, a collection of logical software components including a profile manager, an OOB connector, a secure service, and/or UWB service. The framework may be a FiRa framework.

An “OOB connector” may be a software component for configuring an OOB connection (e.g., BLE connection) between ranging devices. The OOB connector may be a FiRa OOB connector.

A “profile” may be a pre-defined set of UWB and OOB configuration parameters. The profile may be a FiRa Profile.

A “profile manager” is a software component that implements a profile available on the ranging device. The profile manager may be a FiRa profile manager.

A “service” may be an implementation of a use case that provides a service to an end-user.

A “smart ranging device” may be a ranging device that may implement an optional framework API. The smart ranging device may be a FiRa smart device.

A “global dedicated file (GDF)” may be a root level of application specific data including data required to configure a USB session.

A “framework API” may be an API used by a UWB-enabled application to communicate with the framework.

An “initiator” may be a ranging device that initiates a ranging exchange. The initiator may initiate the ranging exchange by sending a first RFRAME (ranging initiation message).

An “object identifier (OID)” may be an identifier of the ADF in the application data structure.

“Out-of-band (OOB)” may be data communication that does not use UWB as an underlying wireless technology.

A “ranging data set (RDS)” may be data (e.g., UWB session key, session ID, etc.) required for configuring a UWB session when it is needed to protect confidentiality, authenticity, and integrity.

A “responder” may be a ranging device that responds to the initiator in a ranging exchange. The responder may respond to the ranging initiation message received from the initiator.

An “STS” may be a ciphered sequence for increasing the integrity and accuracy of ranging measurement timestamps. The STS may be generated from the ranging session key.

A “secure channel” may be a data channel that prevents overhearing and tampering.

A “secure component” may be an entity (e.g., a secure element (SE) or a trusted execution environment (TEE)) having a defined security level that interfaces with a UWBS for the purpose of providing the RDS to the UWBS, for example, when the dynamic STS is used.

An “SE” may be a tamper-resistant secure hardware component that may be used as a secure component in the ranging device.

“Secure ranging” may be ranging based on the STS generated through a strong encryption operation.

A “secure service” may be a software component for interfacing with a secure component, such as an SE or a TEE.

A “service applet” may be an applet on a secure component that handles service specific transactions.

“Service data” may be data defined by a service provider that needs to be transferred between two ranging devices to implement a service.

A “service provider” may be an entity that defines and provides hardware and software required to provide a specific service to an end-user.

A “static STS mode” is an operation mode in which the STS is repeated during a session, and does not need to be managed by the secure component.

A “secure UWB service (SUS) applet” may be an applet on the SE that communicates with the applet to retrieve data needed to enable secure UWB sessions with other ranging devices. In addition, the SUS applet may transfer corresponding data (information) to the UWBS.

A “UWB” service” may be a software component that provides access to the UWBS.

A “UWB session” may be a period from when the controller and the controlee start communication through UWB until the communication stops. A UWB session may include ranging, data transfer, or both ranging and data transfer.

A “UWB session ID” may be an ID (e.g., a 32-bit integer) that identifies the UWB session, shared between the controller and the controller.

A “UWB session key” may be a key used to protect the UWB session. The UWB session key may be used to generate the STS. The UWB session key may be a UWB ranging session key (URSK), and may be abbreviated as a session key.

A “UWB subsystem (UWBS)” is a hardware component implementing the UWB PHY and MAC layers (specifications). The UWBS may have an interface to the framework and an interface to the secure component to search for an RDS.

A “UWB message” may be a message including a payload IE transmitted by the UWB device (e.g., ERDEV). The UWB message may be a message such as a ranging initiation message (RIM), a ranging response message (RRM), a ranging final message (RFM), a control message (CM), a measurement report message (MRM), a ranging result report message (RRRM), a control update message (CUM), and a one-way ranging (OWR) message. If necessary, multiple messages may be merged into one message.

“OWR” may be a ranging scheme using messages transmitted in one direction between a ranging device and one or more other ranging devices. The OWR may be used for measuring a time difference of arrival (TDoA). In addition, the OWR may be used for measuring an AoA at the reception end, rather than measuring the ToDA. In this case, a pair of one advertiser and one observer may be used.

“TWR” may be a ranging scheme capable of estimating a relative distance between two devices by measuring time of flight (ToF) through an exchange of ranging messages between the two devices. A TWR scheme may be one of double-sided two-way ranging (DS-TWR) and single-sided two-way raging (SS-TWR). SS-TWR may be a be a procedure for performing ranging through one round-trip time measurement. For example, SS-TWR may include a transmission operation of a RIM from an initiator to a responder, and a transmission operation of an RRM from a responder to an initiator. DS-TWR may be a procedure for performing ranging through two round-trip time measurements. For example, DS-TWR may include a transmission operation of an RIM from an initiator to a responder, a transmission operation of an RRM from a responder to an initiator, and a transmission operation of an RFM from an initiator to a responder. Through such a ranging exchange (ranging message exchange), time of flight (ToF) may be calculated, and the distance between two devices may be estimated. In a TWR process, the measured AoA information (e.g., AoA azimuth result or AoA elevation result) may be transferred to another ranging device through an RRRM or another message. In this disclosure. TWR may be referred as UWB TWR.

“DL-TDoA” may be referred to as downlink time difference of arrival (DL-TDoA) or a reverse TDoA, overhearing (or receiving) a message of an anchor device by a user equipment (UE) (tag device) may be a basic operation in a process of broadcasting a message or exchanging a message among multiple anchor devices. DL-TDoA may be classified as a type of one way ranging like uplink TDoA. A UE performing the DL-TDoA operation may overhear the messages transmitted by the two anchor devices to calculate a TDoA proportional to the difference of the distances between each anchor device and the UE. The UE may calculate a relative distance to the anchor device by using TDoA with several pairs of anchor devices and use the same for positioning. The operation of the anchor device for DL-TDoA may be similar to that of DS-TWR as defined in IEEE 802.15.4z and may further include other useful time information so that the UE may calculate the TDoA. DL-TDoA may be also referred to as DL-TDoA localization.

An “anchor device” may be referred to as an anchor, a UWB anchor, or a UWB anchor device, and may be a UWB device disposed at a specific location to provide a positioning service. For example, the anchor device may be a UWB device installed by a service provider on a wall, ceiling, structure, etc., in a room, to provide an indoor positioning service. The anchor device may be divided into an initiator anchor and a responder anchor according to the order and role of transmitting messages.

An “initiator anchor” may be referred to as an initiator UWB anchor, an initiator anchor device, or the like, and may announce a start of a specific ranging round. The initiator anchor may schedule a ranging slot for responder anchors operating in the same ranging round to respond. The initiation message of the initiator anchor may be referred to as an initiator downlink TDoA message (DTM), a poll DTM, or a poll message. The initiation message of the initiator anchor may include a transmission timestamp. The initiator anchor may additionally transfer an end message after receiving responses from the responder anchors. The end message of the initiator anchor may be referred to as a final DTM or a final message. The end message may include reply time to the messages sent by the responder anchors. The end message may include a transmission timestamp.

A “responder anchor” may be referred to as a responder UWB anchor, a responder UWB anchor device, a responder anchor device, etc. The responder anchor may be a UWB anchor that responds to an initiation message of an initiator anchor. The message with which the responder anchor responds may include the time of reply to the initiation message. The message with which the responder anchor responds may be referred to as a responder DTM or a response message. The response message of the responder anchor may include a transmission timestamp.

A “tag device” may estimate may estimate its location (e.g., geographical coordinates) by using TDoA measurements based on a DTMs received an anchor device in DL-TDoA. The tag device may have already known the locations of the anchor device. The tag device may be referred to as a UWB tag, a user equipment, and a UWB tag device, and the tag device of the DL-TDoA may be referred to as a DL-TDoA tag or a DT-tag. The tag device may receive a message transmitted by the anchor device, and measure a reception time of the message. The tag device may obtain the geographical coordinates of the anchor device via either an in-band or out-of-band method. The tag device may skip a ranging block when the location update rate is lower than that supported by a network.

A “cluster” may refer to a set of UWB anchors covering a specific area. The cluster may include an initiator UWB anchor and responder UWB anchors responding thereto. For two-dimensional (2D) positioning, one initiator UWB anchor and at least three responder UWB anchors are typically required, and for three-dimensional (3D) positioning, one initiator UWB anchor and at least four responder UWB anchors are required. If the initiator UWB anchor and the responder UWB anchor may be accurately time-synchronized through a separate wired/wireless connection, one initiator UWB anchor and two responder UWB anchors are required for 2D positioning, and one initiator UWB anchor and three responder UWB anchors are required for 3D positioning. Unless otherwise stated, it is assumed that there is no separate device for wired/wireless time synchronization between UWB anchors. The cluster area may be a space formed by the UWB anchors constituting the cluster. To support the positioning service for a wide area, a plurality of clusters may be configured to provide the positioning service to the UE. The cluster may be also referred to as a cell. The operation of the cluster may be understood as the operation of anchor(s) belonging to the cluster.

An “AoA” is an angle of arrival of a reception signal, and may be represented by a relative angle such as AoA azimuth and AoA elevation. For example, it may be assumed that a measurement device is a mobile phone having a display, a Y-axis is a vertical display axis of the mobile phone, an X-axis is a horizontal display axis of the mobile phone, and a Z-axis is orthogonal to the display of the mobile phone. In this case, the AoA azimuth angle may be a relative angle between an input signal projected on the XZ plane and the Z-axis, and the AoA elevation angle may be a relative angle between the input signal and the XZ plane.

In a case of TWR, a controller (initiator) may measure the AoA azimuth for the RRM, and may transmit the AoA azimuth measured through a UCI notification message. A controlee (responder) may measure the AoA azimuth for the RIM message, and transmit the AoA azimuth measured through the RRRM.

In a case of TWR, a controller (initiator) may measure the AoA elevation for the RRM, and may transmit the AoA elevation measured through a UCI notification message. A controlee (responder) may measure the AoA elevation for the RIM message, and transmit the AoA elevation measured through the RRRM.

In a case of OWR, an observer may measure the AoA azimuth and the AoA elevation for an AoA measurement message.

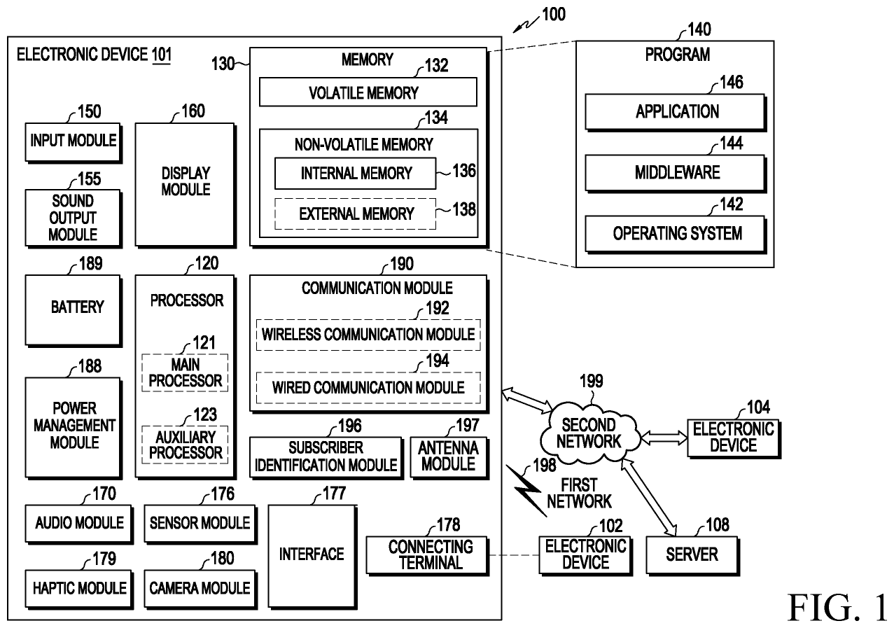

FIG. 1 is a block diagram schematically illustrating an electronic device.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active (e.g., executing an application) state. According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial model may be generated through machine learning. Such learning may be performed, e.g., by the electronic device 101 where the artificial intelligence model is performed or via a separate server (e.g., the server 108). A learning algorithm may include, for example, supervised learning, unsupervised learning, semi-supervised learning, or reinforcement learning, but is not limited to the above examples. The artificial intelligence model may include a plurality of artificial neural network layers. The artificial neural network may be one of a deep neural network (DNN), a convolutional neural network (CNN), a recurrent neural network (RNN), a restricted Boltzmann machine (RBM), a deep brief network (DBN), a bidirectional recurrent deep neural network (BRDNN), a deep Q-network, and a combination of two or more thereof, but is not limited to the above examples. The artificial intelligence model may, additionally or alternatively, include a software structure other than the hardware structure.

The memory 130 may store various data used by at least one component (e.g., the processor 120 or the sensor module 176) of the electronic device 101. The data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or an external electronic device (e.g., an electronic device 102 (e.g., a speaker or a headphone)) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be incorporated into a single component (e.g., a single chip), or may be implemented as multi components (e.g., multiple chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support high-speed transmission of high-capacity data (enhanced mobile broadband (eMBB)), terminal power minimization and multi-terminal access (massive machine type communications (mMTC)), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed at a first surface (e.g., the lower surface) of the printed circuit board or adjacent thereto and capable of supporting specified high-frequency bands (e.g., mmWave bands), and a plurality of antennas (e.g., an array antenna) disposed at a second surface (e.g., the upper or side surface) of the printed circuit board or adjacent thereto and capable of transmitting or receiving signals in the specified high-frequency bands.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To this end, a cloud computing, distributed computing, mobile edge computing (MEC), or client-server computing technology may be used, for example. The electronic device 101 may provide ultralow-latency services using, for example, distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments set forth herein may be one of various types of electronic devices. The electronic device may include, for example, a portable communication device (e.g., a smart phone), a computer device, a portable multimedia device, a portable medical device, a camera, a wearable device, or a home appliance. The electronic device according to embodiments of the disclosure is not limited to those described above.

It should be appreciated that various embodiments of the disclosure and the terms used therein are not intended to limit the technological features set forth herein to particular embodiments and the disclosure includes various changes, equivalents, or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B.” “at least one of A and B,” “at least one of A or B,” “A, B, or C.” “at least one of A, B, and C,” and “at least one of A, B, or C,” may include any one or all possible combinations of the items enumerated together in a corresponding one of the phrases. Such terms as “a first,” “a second.” “the first,” and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

As used in various embodiments of the disclosure, the term “module” may include a unit implemented in hardware, software, or firmware, and may be interchangeably used with other terms, for example, “logic.” “logic block,” “component.” or “circuit”. The “module” may be a single integrated component, or a minimum unit or part thereof, adapted to perform one or more functions. For example, according to an embodiment, the “module” may be implemented in the form of an application-specific integrated circuit (ASIC).

Various embodiments as set forth herein may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Herein, the term “non-transitory.” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, methods according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities may be separately disposed in another element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

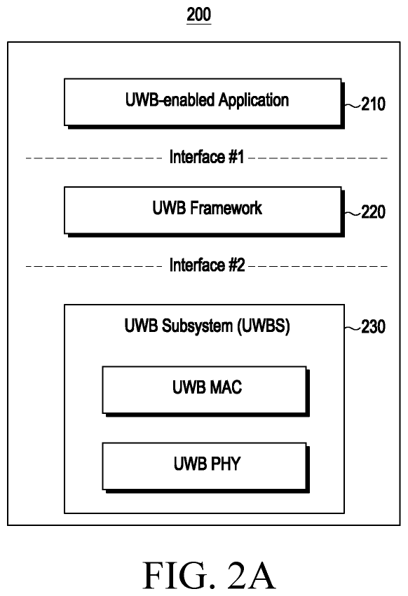

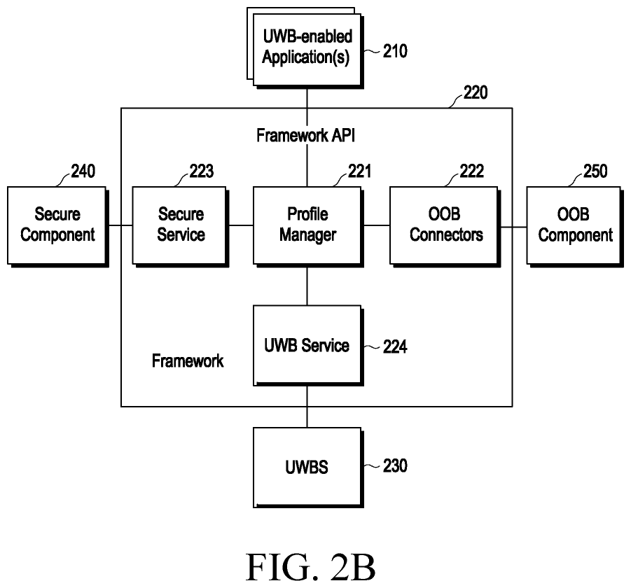

FIG. 2A illustrates exemplary architecture of a UWB device according to an embodiment of the disclosure.

In the disclosure, a UWB device 200 may be an electronic device supporting UWB communication. For example, the UWB device 200 may be an example of the electronic device 101 of FIG. 1.

The UWB device 200 may be, for example, a ranging device supporting UWB ranging. In an embodiment, the ranging device may be an enhanced ranging device (ERDEV) or a FiRa device.

In the embodiment of FIG. 2A, the UWB device 200 may interact with other UWB devices through a UWB session.

In addition, the UWB device 200 may implement a first interface (Interface #1) corresponding to an interface between a UWB-enabled application 210 and a UWB framework 220, and the first interface allows the UWB-enabled application 110 on the UWB device 200 to use UWB capabilities of the UWB device 200 in a predetermined manner. In an embodiment, the first interface may be a framework API or a proprietary interface, but is not limited thereto.

In addition, the UWB device 200 may implement a second interface (Interface #2) corresponding to an interface between the UWB framework 210 and a UWB subsystem (UWBS) 230. In an embodiment, the second interface may be a UWB command interface (UCI) or a proprietary interface, but is not limited thereto.

Referring to FIG. 2A, the UWB device 200 may include the UWB-enabled application 210, the framework (UWB framework) 220, and/or the UWBS 230 including a UWB MAC layer and a UWB physical layer. According to an embodiment, some entities may not be included in the UWB device, or an additional entity (e.g., a secure layer) may be further included.

The UWB-enabled application 210 may trigger configuration of a UWB session by the UWBS 230 by using the first interface. In addition, the UWB-enabled application 210 may use one of pre-defined profiles. For example, the UWB-enabled application 210 may use one of profiles defined in FiRa or a custom profile. The UWB-enabled application 210 may use the first interface to handle related events, such as service discovery, ranging notifications, and/or error conditions.

The framework 220 may provide access to profiles, individual-UWB configurations, and/or notifications. In addition, the framework 220 may support at least one of a functions such as a function for UWB ranging and transaction execution, a function for providing an interface to the UWBS 230, or a function for estimating the location of the device 200. The framework 220 may be a set of software components. As described above, the UWB-enabled application 210 may interface with the framework 220 through the first interface, and the framework 220 may interface with the UWBS 230 through the second interface.

In the disclosure, the UWB-enabled application 210 and/or the framework 220 may be implemented by an application processor (AP) (or a processor). Accordingly, in the disclosure, an operation of the UWB-enabled application 210 and/or the framework 220 may be understood to be performed by the AP (or the processor). In the disclosure, the framework may be referred to as an AP or a processor.

The UWBS 230 may be a hardware component including the UWB MAC layer and the UWB physical layer. The UWBS 230 may perform UWB session management, and may communicate with the UWBS of another UWB device. The UWBS 230 may interface with the framework 120 through the second interface, and may acquire security data from a secure component. In an embodiment, the framework (or the application processor) 220) may transmit a command to the UWBS 230 through the UCI, the UWBS 230) may transfer a response to the command to the framework 220. The UWBS 230 may transfer a notification to the framework 120 through the UCI.

FIG. 2B illustrates an exemplary configuration of a framework of a UWB device according to an embodiment of the disclosure.

A UWB device of FIG. 2B may be an example of the UWB device of FIG. 2A.

Referring to FIG. 2B, the framework 220 may include, for example, software components such as a profile manager 221, an OBB connector 222, a secure service 223, and/or a UWB service 224.

The profile manager 221 may perform the role of managing profiles available on the UWB device. Here, the profile may be a set of parameters required to configure communication between UWB devices. For example, the profile may include a parameter indicating an OOB secure channel to be used, a UWB/OOB configuration parameter, a parameter indicating whether the use of a particular secure component is mandatory, and/or a parameter related to a file structure of the ADF. The UWB-enabled application 210 may communicate with the profile manager 221 through the first interface (e.g., the framework API).

The OOB connector 222 may perform the role of configuring an OOB connection with another device. The OOB connector 222 may handle an OOB stage including a discovery stage and/or a connection stage. An OOB component (e.g., a BLE component) 250) may be connected to the OOB connector 222.

The secure service 223 may perform the role of interfacing with the secure component 240) such as an SE or a TEE.

The UWB service 224 may perform the role of managing the UWBS 230. The UWB service 224 may implement a second interface to provide access from the profile manager 221 to the UWBS 230.

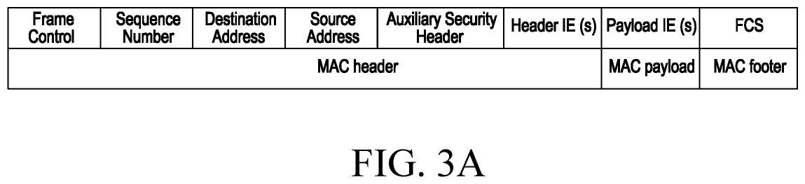

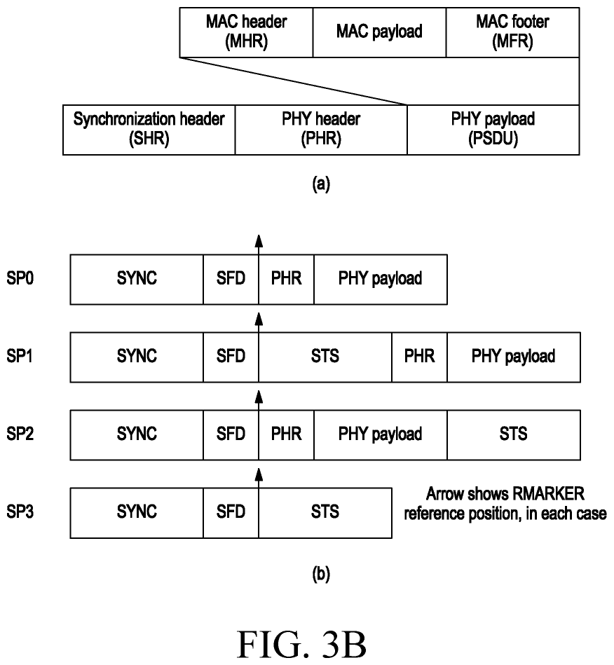

FIG. 3A illustrates a structure of a UWB MAC frame according to an embodiment of the disclosure.

In the disclosure, a UWB MAC frame may be abbreviated as a MAC frame or a frame. In an embodiment, the UWB MAC frame may be used to transfer UWB-related data (e.g., a UWB message, a ranging message, control information, service data, application data, etc.).

Referring to FIG. 3A, the UWB MAC frame may include a MAC header (MHR), a MAC payload, and/or a MAC footer (MFR).

### (1) MAC Header

A MAC header may include a frame control field, a sequence number field, a destination address field, a source address field, an auxiliary security header field, and/or at least one header IE field. According to an embodiment, some of the above-described fields may not be included in the MAC header, and additional fields may be further included in the MAC header.

In an embodiment, the frame control field may include a frame type field, a security enabled field, a frame pending field, an ACK request field (AR field), a PAN ID compression field (a PAN ID present field), a sequence number suppression field, an IE present field, a destination addressing mode field, a frame vision field, and/or a source addressing mode field. According to an embodiment, some of the above-described fields may not be included in the frame control field, and an additional field may be further included in the frame control field.

A description of each field is as follows.

The frame type field may indicate the type of a frame. In an embodiment, the type of the frame may include a data type and/or a multipurpose type.

The security enabled field may indicate whether an auxiliary security header field exists. The auxiliary security header field may include information required for security processing.

The frame pending field may indicate whether the device for transmitting the frame has more data for a recipient. That is, the frame pending field may identify whether there is a pending frame for the recipient.

The ACK request field (AR field) may indicate whether an acknowledgement to reception of a frame is required from the recipient.

The PAN ID compression field (PAN ID present field) may indicate whether there is a PAN ID field.

The sequence number suppression field may indicate whether there is a sequence number field. The sequence number field may indicate a sequence identifier for a frame.

The IE present field may indicate whether the header IE field and the payload IE field are included in a frame.

The destination addressing mode field may indicate whether the destination address field includes a short address (e.g., 16 bits) or an extended address (e.g., 64 bits). The destination address field may indicate an address of the recipient of the frame.

The frame version field may indicate the version of a frame. For example, the frame version field may be configured as a value indicating IEEE std 802.15.4z-2020.

The source addressing mode field may indicate whether a source address field exists, and may indicate when there is a source address field, whether the source address field includes a short address (e.g., 16 bits) or an extended address (e.g., 64 bits). The source address field may indicate an address of an originator of the frame.

### (2) MAC Payload

A MAC payload may include at least one payload IE field. In an embodiment, the payload IE field may include a vendor specific nested IE.

### (3) MAC Footer

A MAC footer may include an FCS field. The FCS field may include 16-bit CRC or 32-bit CRC.

FIG. 3B illustrates a structure of a UWB PHY packet according to an embodiment of the disclosure.

Part (a) of FIG. 3B illustrates an exemplary structure of a UWB PHY packet to which an STA packet configuration is not applied, and part (b) of FIG. 3B illustrates an exemplary structure of a UWB PHY packet to which an STS packet configuration is applied. The UWB PHY packet may be referred to as a PHY packet, a PHY PDU (PPDU), or a frame.

Referring to part (a) of FIG. 3B, a PPDU may include a synchronization header (SHR), a PHY header (PHR), and a PHY payload (PSDU). The PSDU may include a MAC frame, and as shown in FIG. 2, the MAC frame may include a MAC header (MHR), a MAC payload, and/or a MAC footer (MFR). The synchronization header part may be referred to as a preamble, and a part including the PHY header and the PHY payload may be referred to as a data part.

The synchronization header may be used for synchronization of signal reception, and may include a SYNC field and a start-of-frame delimiter (SFD).

The SYNC field may be a field including multiple preamble symbols used for synchronization between transmission/reception devices. The preamble symbol may be configured through one of pre-defined preamble codes.

The SFD field may be a field indicating the end of the SHR and the start of the data field.

The PHY header may provide information on the configuration of the PHY payload. For example, the PHY header may include information on the length of the PSDU, information on whether a current frame is an RFRAME (or a data frame), etc.

The PHY layer of the UWB device may include an optional mode for providing a reduced on-air time for high density/low power operation. In this case, the UWB PHY packet may include an encrypted sequence (i.e., STS) to increase the integrity and accuracy of the ranging measurement timestamp. An STS may be included in the STS field of the UWB PHY packet and be used for security ranging.

Referring to part (b) of FIG. 3B, in a case of STS packet (SP) configuration 0 (SP0), the STS field is not included in the PPDU (SP0 packet). In a case of SP configuration 1 (SP1), the STS field is positioned immediately after the SFD field and before the PHR field (SP1 packet). In a case of SP configuration 2 (SP2), the STS field is positioned after the PHY payload (SP2 packet). In a case of SP configuration 3 (SP3), the STS field is positioned immediately after the SFD field, and the PPDU does not include the PHR and data field (PHY payload) (SP3 packet). In other words, in a case of SP3, the PPDU does not include the PHR and PHY payload.

As illustrated in part (b) of FIG. 3B, each UWB PHY packet may include RMARKER for defining a reference time, and the RMARKER may be used to obtain a transmission time (transmission timestamp), a reception time (reception timestamp), and/or a time period of a ranging message (frame) in the UWB ranging procedure. For example, the UWB PHY packet may include RMARKER within the preamble or at the end of the preamble.

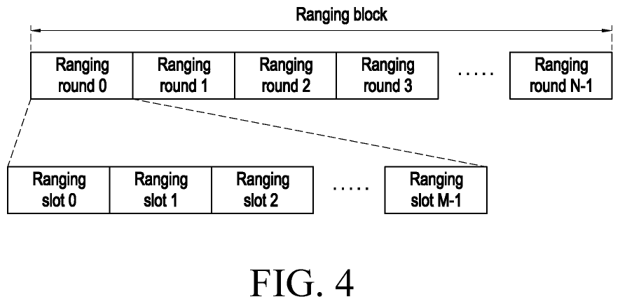

FIG. 4 illustrates an example of a structure a ranging block and rounds used for UWB ranging according to an embodiment of the disclosure.

In the disclosure, a ranging block refers to a time period. A ranging round may be a period of sufficient period for completing one entire range-measurement cycle in which a set of UWB devices participating in a ranging exchange involves. A ranging slot may be a sufficient period for transmission of at least one RFRAME (e.g., ranging initiation/replay/final message, etc.).

As shown in FIG. 4, one ranging block may include at least one ranging round, and each ranging round may include at least one ranging slot.

When the ranging mode is a block-based mode, a mean time between contiguous ranging rounds may be a constant. Alternatively, when the ranging mode is an interval-based mode, the time between contiguous ranging rounds may be dynamically changed. That is, the interval-based mode may adopt a time structure having an adaptive spacing.

The number and period of slots included in the ranging round may be changed between ranging rounds.

In the disclosure, a ranging block, a ranging round, and a ranging slot may be abbreviated as a block, a round, and a slot, respectively.

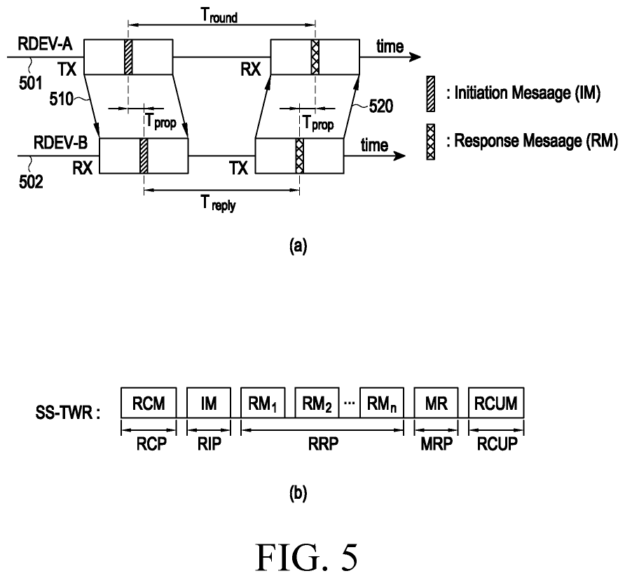

FIG. 5 illustrates an SS-TWR ranging procedure according to an embodiment of the disclosure.

Part (a) of FIG. 5 illustrates a schematic operation of an SSR-TWR ranging procedure according to an embodiment of the disclosure.

In the embodiment of part (a) of FIG. 5, a first electronic device 501 and a second electronic device 502 may be the UWB device of FIG. 1 or FIG. 2 (e.g., RDEV, ERDEV, or FiRa device). In the embodiment of part (a) of FIG. 5, the first electronic device 501 may perform the role of an initiator, and the second electronic device 502 may perform the role of a responder.

In the embodiment of part (a) of FIG. 5, the SS-TWR ranging procedure may be a procedure of performing ranging through one round-trip time measurement.

Referring to part (a) of FIG. 5, in operation 510, the first electronic device 501 may initiate ranging exchange by transmitting an initiation message (IM) to the second electronic device 502.

In operation 520, the second electronic device 502 may complete the ranging exchange by transmitting a response message (RM) to the first electronic device 501.

Each electronic device 501 or 502 may measure a transmission time and a reception time of a message and calculate a round-trip time (T_{round}) and a reply time (T_{reply}). Here, the round-trip time (T_{round}) may be a difference between a time point at which the first electronic device 501 transmits the IM to the second electronic device 502 and a time point at which the first electronic device 501 receives the RM from the second electronic device 502. The reply time (T_{reply}) may be a difference between a time point at which the second electronic device 502 receives the IM from the first electronic device 501 and a time point at which the second electronic device 502 transmits the RM to the first electronic device 501.

As an embodiment, the UWB message/frame (or the UWB PHY packet (e.g., the UWB PHY packet of FIG. 3B) transferring the UWB message) may include a marker (RMARKER) for defining a reference time, and the electronic device may perform ranging measurement through the RMARKER.

For example, the first electronic device 501 may measure the time between the RMARKER included in the packet/frame transmitted to the second electronic device 502 and the RMARKER included in the packet/frame received from the second electronic device 502, as T_{round}. The second electronic device 402 may measure the time between the RMARKER included in the packet/frame received from the first electronic device 401 and the RMARKER included in the packet/frame transmitted to the first electronic device 401, as T_{reply}.

The time-of-flight (ToF) time (Tₚᵣₒₚ) may be calculated by Equation 1 below. Tₚᵣₒₚ may also be referred to as \hat{T}ₚᵣₒₚ.

$${\hat{T}}_{prop} = \frac{1}{2} ( {T}_{round} - {T}_{reply} ) \qquad [ Equation 1 ]$$

Part (b) of FIG. 5 illustrates an exemplary message exchange operation of an SS-TWR ranging procedure according to an embodiment of the disclosure.

Referring to part (b) of FIG. 5, a SS-TWR ranging procedure may include at least one phase for message exchange. As an embodiment, the SS-TWR ranging procedure may include a ranging control phase (RCP), a ranging initiation phase (RIP), a ranging response phase (RRP), a measurement report phase (MRP), and/or a ranging control update phase (RCUP). Each phase is described below.

Ranging control phase (RCP): A phase in which a controller device transmits a ranging control message (RCM).

Ranging initiation phase (RIP): A phase in which an initiator device transmits a ranging initiation message (RIM) to a responder device. In this disclosure, the RIM may be referred to as an IM.

Ranging response phase (RRP): A phase in which a responder device transmits a ranging response message (RRM) to an initiator device. In this disclosure, the RRM may be referred to as an RM.

Measurement report phase (MRP): A phase in which devices participating in ranging exchange ranging measurement and related service information through a measurement report (MR).

Ranging control update phase (RCUP): A phase in which a controller device transmits a ranging control update message (RCUM). If present, the RCUP may be the last slot of a set of ranging rounds designated by the RCM.

A phase including the RIP and the RRP may be referred to as a ranging phase (RP).

According to an embodiment, the initiator device may also perform the role of a controller device, and in this case, the RCP and the RIP may be merged into one phase.

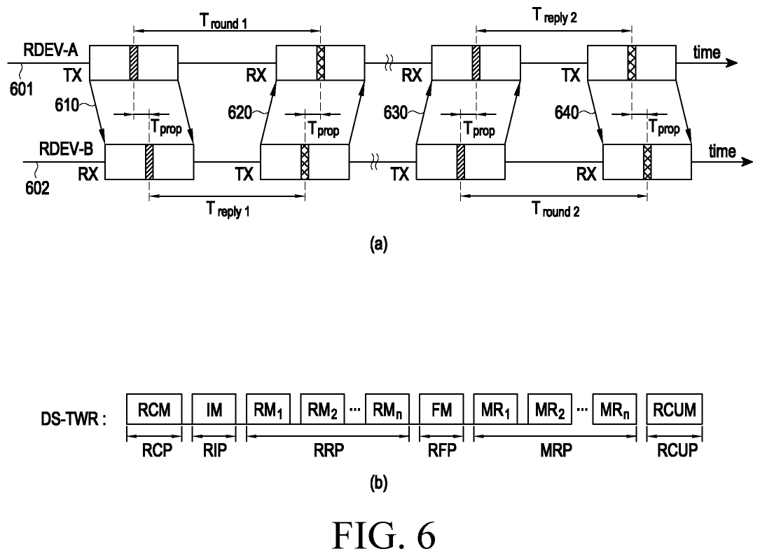

FIG. 6 illustrates a DS-TWR ranging procedure according to an embodiment of the disclosure.

Part (a) of FIG. 6 illustrates a schematic operation of a DS-TWR ranging procedure according to an embodiment of the disclosure.

In the embodiment of part (a) of FIG. 6, a first electronic device 601 and a second electronic device 602 may be the UWB device (e.g., RDEV, ERDEV, or FiRa device) of FIG. 1 or FIG. 2. In the embodiment of part (a) of FIG. 6, the first electronic device 601 may perform the role of an initiator, and the second electronic device 602 may perform the role of a responder.

In the embodiment of part (a) of FIG. 6, an SS-TWR ranging procedure may be a procedure of performing ranging through two round-trip time measurements. In this case, the first round-trip measurement is initiated by the first electronic device 601, and the second round-trip measurement is initiated by the second electronic device 602.

Referring to part (a) of FIG. 6, in operation 610, the first electronic device 601 may transmit a first initiation message to the second electronic device 602 to initiate measurement of a first round-trip time when the second electronic device 602 responds. In operation 620, the second electronic device 602 may transmit a first response message corresponding to the first initiation message to the first electronic device 601.

In operation 630, the second electronic device 602 may transmit a second initiation message to the first electronic device 601 to initiate measurement a second round-trip time when the first electronic device 601 responds. In operation 640, the first electronic device 601 may transmit a second response message corresponding to the second initiation message to the second electronic device 602. As an embodiment, the second response message may be an end message (ranging end message).

According to an embodiment, the first response message of the second electronic device 602 for the measurement of the first round-trip time may be used as the second initiation message of the second electronic device 602 for the measurement of the second round-trip time. In this case, operations 620 and 630 may be the same operation.

Each electronic device 601 or 602 may measure a transmission time and a reception time of the message, and may calculate a first round-trip time T_{round1}/second round-trip time T_{round2} and a first response time T_{reply1}/second response time T_{reply2}.

Here, the first round-trip time T_{round1} may be a difference between a time point at which the first electronic device 601 transmits the first initiation message to the second electronic device 602 and a time point at which the first electronic device 601 receives the first response message from the second electronic device 602. The second round-trip time T_{round2} may be a difference between a time point at which the second electronic device 602 transmits the second initiation message to the first electronic device 601 and a time point at which the second electronic device 602 receives the second response message from the first electronic device 601.

Here, the first response time T_{reply1} may be a difference between a time point at which the second electronic device 602 receives the first initiation message from the first electronic device 601 and a time point at which the second electronic device 602 transmits the first response message to the first electronic device 501. The second response time T_{reply2} may be a difference between a time point at which the first electronic device 601 receives the second initiation message from the second electronic device 602 and a time point at which the first electronic device 601 transmits the second response message to the second electronic device 602.

As an embodiment, the UWB message/frame (or the UWB PHY packet (e.g., the UWB PHY packet of FIG. 3B) transferring the UWB message) may include a marker (RMARKER) for defining a reference time, and the electronic device may perform ranging measurement through the RMARKER.

For example, the first electronic device 601 may measure a time between RMARKER included in a first packet/first frame transmitted to the second electronic device 602 and RMARKER included in a second packet/second frame received from the second electronic device 602, as T_{round1}. The second electronic device 602 may measure a time between RMARKER included in the first packet/first frame received from the first electronic device 601 and RMARKER included in the second packet/second frame transmitted to the first electronic device 601, as T_{reply1}. The second electronic device 602 may measure a time between RMARKER included in a third packet/third frame transmitted to the first electronic device 601 and RMARKER included in a fourth packet/fourth frame received from the first electronic device 601, as T_{round2}. The first electronic device 601 may measure a time between RMARKER included in the third packet/third frame received from the second electronic device 602 and RMARKER included in the fourth packet/fourth frame transmitted to the second electronic device 602, as T_{reply2}.

The time-of-flight (ToF) time Tₚᵣₒₚ may be calculated by Equation 2 below. Tₚᵣₒₚ may also be referred to as \hat{T}ₚᵣₒₚ.

$${\hat{T}}_{prop} = \frac{( {T}_{round 1} \times {T}_{round 2} - {T}_{reply 1} \times {T}_{reply 2} )}{( {T}_{round 1} + {T}_{round 2} + {T}_{reply 1} + {T}_{reply 2} )} \qquad [ Equation 2 ]$$

Part (b) of FIG. 6 illustrates an exemplary message exchange operation of a DS-TWR ranging procedure according to an embodiment of the disclosure.

Referring to part (b) of FIG. 6, a DS-TWR ranging procedure may include at least one phase for message exchange. As an embodiment, the DS-TWR ranging procedure may include a ranging control phase (RCP), a ranging initiation phase (RIP), a ranging response phase (RRP), a ranging final phase (RFP), a measurement report phase (MRP), and/or a ranging control update phase (RCUP). Each phase is described below.

Ranging control phase (RCP): A phase in which a controller device transmits a ranging control message (RCM).

Ranging initiation phase (RIP): A phase in which an initiator device transmits a ranging initiation message (RIM) to a responder device.

Ranging response phase (RRP): A phase in which a responder device transmits a ranging response message (RRM) to an initiator device.

Ranging final phase (RFP): A phase in which an initiator device transmits a ranging final message (RFM) to a responder device.

Measurement report phase (MRP): A phase in which devices participating in ranging exchange ranging measurement and related service information through a measurement report (MR).

Ranging control update phase (RCUP): A phase in which a controller device transmits a ranging control update message (RCUM). If present, the RCUP may be the last slot of a set of ranging rounds designated by the RCM.

A phase including the RIP, the RRP, and the RFP may be referred to as a ranging phase (RP).

According to an embodiment, the initiator device may also perform the role of a controller device. In this case, the RCP and the RIP may be merged into one phase.

The disclosure provides a motion detection method for enhancing a recognition rate of a gesture (or motion).

In the motion detection method of the disclosure, data (UWB data) of UWB ranging of a one-to-one (1:1) or one-to-many (1:N) mode between an electronic device (e.g., a VR device) including an application (e.g., a VR application) using a gesture detection result and a peripheral device (e.g., a VR peripheral device) may be used for gesture detection. In addition, the motion detection method of the disclosure, together with the UWB data, sensor data (e.g., IMU sensor data) may be used for gesture detection.

As an embodiment, the UWB ranging may be UWB TWR (e.g., DS-TWR/SS-TWR) and/or UWB OWR.

As an embodiment, the UWB data may include ranging result data (e.g., the distance between devices or ToF) acquired through the UWB ranging. AoA data, and/or CIR data.

The UWB data and the sensor data may be acquired from both a main electronic device (e.g., VR device) and a peripheral device (e.g., a VR peripheral device), and the UWB data and/or the sensor data may be transferred to another device through UWB in-band communication or UWB OOB communication. The UWB data and the sensor data may be used for gesture detection by both the main electronic device and the peripheral device or one of the main electronic device and the peripheral device. In the motion detection method of the disclosure, a new defined data information element for transferring the UWB data and/or sensor data to another device may be used.

In the motion detection method of the disclosure, a pretrained model may be used for motion detection. As an embodiment, the pretrained model may be an SVM-based model or a CNN-based model.

When the period of the UWB ranging for acquiring the UWB data increases, motion recognition performance and power consumption decrease, and when the period of the UWB ranging decreases, motion recognition performance and power consumption increase. Accordingly, in consideration of an application, target power consumption, target motion recognition performance, etc., the period of the UWB ranging needs to be adaptively adjusted. The motion detection method of the disclosure can adaptively adjust the period (or interval) of the UWB ranging in consideration of the application, target power consumption, target motion recognition performance, etc. The period of the UWB ranging may be determined (or adjusted) by the main electronic device or the peripheral device, and the determined (or adjusted) period may be transferred to another device through a UWB message (e.g., a ranging control message). Thereafter, the two devices may perform the UWB ranging at the same determined (or adjusted) ranging period.

In the motion detection method of the disclosure, the gesture detection result may be transferred to a corresponding application (e.g., a VR application) as a UX input. In the motion detection method of the disclosure, a newly defined API may be used to transfer the gesture detection result to the application.

In the motion detection method of the disclosure, a general wearable device (e.g., watch/ring-type wearable device) as well as a specific wearable device (e.g., a VR haptic device) of the corresponding application (e.g., VR application) may be used as a peripheral device.

Hereinafter, with reference to each drawing, various embodiments of the motion detection method of the disclosure are described. Hereinafter, for convenience of description, various embodiments of the motion detection method of the disclosure are described by taking a VR device and a peripheral device as an example, but the disclosure is not limited thereto. For example, an AR device/XR device and a peripheral device may be used.

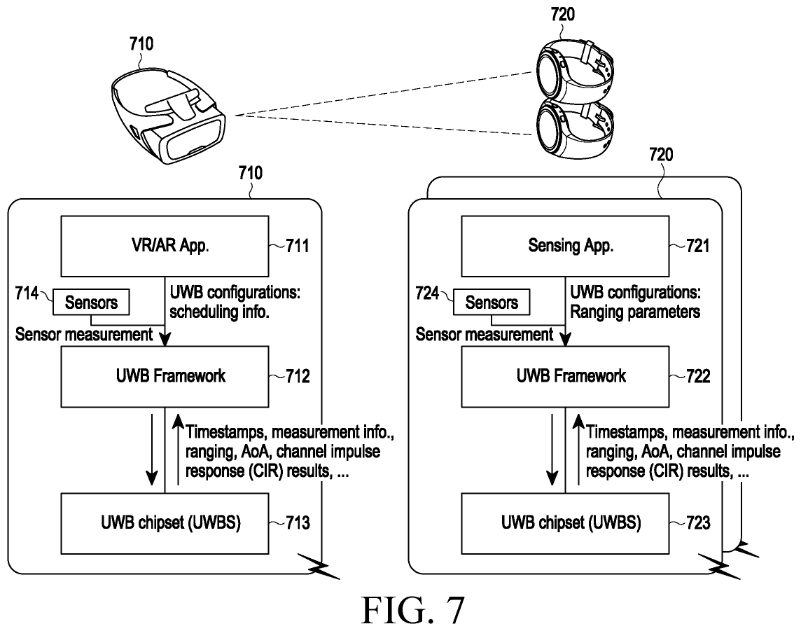

FIG. 7 illustrates an example of a body area network (BAN) supporting UWB communication according to an embodiment of the disclosure.

In the disclosure, the BAN may be a network including at least one electronic device which can be located on the body of a user.

The BAN may include at least one electronic device supporting UWB communication. For example, as illustrated in FIG. 7, the BAN may include a VR device 710 supporting UWB communication and at least one peripheral device 720, but the disclosure is not limited thereto. In addition, the number of UWB-enabled electronic devices included in the BAN may be also different from the number shown in FIG. 7. In the disclosure, the VR device 710 may be referred to as a first electronic device, and the peripheral device 720 may be referred to as a second electronic device.

Referring to FIG. 7, the VR device 710 and the at least one peripheral device 720 may form a single-ranging group BAN. As an example, the VR device 710 may perform the role of a controller/initiator for UWB ranging (e.g., TWR), and the peripheral device 720 may perform the role of a controlee/responder for UWB ranging (e.g., TWR), but the disclosure is not limited thereto. For example, the VR device 710 and the peripheral device 720 may perform different roles for UWB ranging (e.g., TWR).

The VR device 710 may include at least one application 711 (e.g., VR application), a UWB framework 712, a UWB subsystem (UWBS) 713, and/or at least one sensor 714. The UWBS 713 may be referred to as a UWB chip (UWB chipset).

The peripheral device 720 may include at least one application 721 (e.g., a sensing application), a UWB framework 722, a UWB subsystem (UWBS) 723, and/or at least one sensor 724. In the disclosure, the UWBS 723 may be referred to as a UWB chip (UWB chipset).

The application 711 or 721, the UWB framework 712 or 722, and the UWB subsystem (UWBS) 713 or 723 may be an example of the UWB-enabled application 210, the UWB framework 220, and the UWB subsystem (UWBS) 230 of FIG. 2A. The description of each element may refer to the description made in FIG. 2A above.

Hereinafter, an operation and signal flow of each element are described.

### (1) Application 711 or 721

The application 711 may transfer a (1-1)^{th} signal to the UWB framework 712. In an embodiment, the (1-1)^{th} signal may include UWB configuration information. The UWB configuration information may include configuration information for UWB ranging. For example, the UWB configuration information may include information on the type of UWB ranging (e.g., SS-TWR, DS-TWR, or OWR) and/or scheduling information (e.g., scheduling information for TWR (SS-TWR/DS-TWR)) for UWB ranging. In addition, the UWB configuration information may further include at least one of a UWB channel number for the UWB ranging, a preamble CI, an STS index value for generating an STS, a service identifier, or key information for data encryption/decryption. The UWB configuration information may be transferred to the UWBS 713 using UCI through a framework.

The application 721 may transfer a (1-2)^{th} signal to the UWB framework 722. In an embodiment, the (1-2)^{th} signal may include UWB configuration information. The UWB configuration information may include configuration information for UWB ranging. For example, the UWB configuration information may include ranging parameters for UWB ranging (e.g., SS-TWR, DS-TWR, or OWR). In addition, the UWB configuration information may further include at least one of a UWB channel number for the UWB ranging, a preamble CI, an STS index value for generating STS, a service identifier, or key information for data encryption/decryption.

### (2) UWB Framework 712 or 722

The UWB frameworks 712 and 722 may receive the (1-1)^{th} signal and (1-2)^{th} signal from the applications 711 and 712, respectively, may receive a (3-1)^{th} signal and a (3-2)^{th} signal from the UWBSs 713 and 723, respectively, and may receive a (4-1)^{th} signal and a (4-2)^{th} signal from one or more sensors 712 and 722, respectively.

In an embodiment, the (3-1)^{th} signal/(3-2)^{th} signal may include data acquired from a corresponding device through a UWB ranging procedure. For example, the (3-1)^{th} signal/(3-2)^{th} signal may include at least one of information on transmission/reception timestamps of ranging messages for corresponding UWB ranging, measurement information (e.g., response time information), ranging data (e.g., a TWR/OWR ranging result), AoA data, and channel impulse response (CIR) data, which are acquired from each corresponding device.

In an embodiment, the (4-1)^{th} signal/(4-2)^{th} signal may include sensor measurement information. The sensor measurement information may include sensing data measured from at least one inertial measurement unit (IMU) sensor of a corresponding device. For example, the sensing measurement information may include information on the acceleration for the x, y, or z-axis of a terminal, measured from an acceleration sensor, and/or information on an angular speed for the x, y, or z-axis of a terminal, measured through an inertial sensor.

The UWB framework 712 or 722 may perform control of the UWB ranging based on information included in at least one received signal. For example, the UWB framework 712 of the VR device 710 may adaptively adjust a UWB ranging period (or interval), based on information on the at least one received signal. Alternatively, the adjustment of the UWB ranging period (or interval) may be performed by the application 711 of the VR device 710.

The UWB frameworks 712 and 722 may transfer the (2-1)^{th} signal and the (2-2)^{th} signal to the UWBSs 713 and 723, respectively. In an embodiment, the (2-1)^{th} signal/(2-2)^{th} signal (712s or 722s) may include ranging parameters for the corresponding UWB ranging. For example, the (2-1)^{th} signal of the UWB framework 712 may include information on the UWB ranging period.

### (3) UWBS 713 or 723

Each of the UWBSs 713 and 723 may transmit/receive at least one ranging message.

For example, in a case of DS-TWR, the UWBS 713 of the VR device 710 may transmit an RIM and an FM and receive an RRM, and the UWBS 723 of the peripheral device 720 may transmit the RRM and receive the RIM and the FM.

For example, in a case of SS-TWR, the UWBS 713 of the VR device 710 may transmit the RIM and receive the RRM, and the UWBS 723 of the peripheral device 720 may transmit the RRM and receive the RIM.

In a case of OWR, the UWBS 713 of the VR device 710 may transmit OWR and the UWBS 723 of the peripheral device 720 may receive OWR, or the UWBS 723 of the peripheral device 720 may transmit OWR and the UWBS 713 of the VR device 710 may receive OWR.

The UWBS 713 or 723 may perform a localization operation based on information included in the at least one received ranging message.

### (4) at Least One Sensor 714 or 723

Each of the at least one sensor 714 or 723 may acquire sensing data by sensing a surrounding environment. As an embodiment, the sensor 714 or 723 may be an IMU sensor including, for example, an acceleration sensor and/or an inertial sensor.

The at least one sensor 714 and 723 may transfer the (4-1)^{th} signal and the (4-2)^{th} signal including sensor measurement information to the UWB frameworks 712 and 722, respectively.

FIG. 8 illustrates an example of arrangement of electronic devices included in a BAN supporting UWB communication according to an embodiment of the disclosure.

In the embodiment of FIG. 8, a BAN may include one VR device 810 and one or more peripheral devices 820, 830, and 840.

Referring to FIG. 8, the VR device 810 may be worn on the head of a user. For example, the VR device 810 may be a wearable device (e.g., HMD) worn on the head of a user.

A first peripheral device 820 may be worn on the wrist (e.g., one wrist or both wrists) or a finger (e.g., one finger or both fingers) of the user. For example, the first peripheral device 820 may be a band/watch-type wearable device worn on the wrist of the user, or may be a ring-type wearable device worn on the finger of the user.

A second peripheral device 830 is a mobile phone of the user, and may be located in the pocket of the user.

A third peripheral device 840 may be mounted in a shoe of the user. For example, the third peripheral device 840 may be a wearable device mounted in a shoe of the user.

As illustrated in FIG. 8, devices in the BAN may be located in various body parts of the user, and acquire data for determining the gesture (or pose) of the user. For example, devices in the BAN may acquire operation data (e.g., ranging data, AoA data, CIR data, and/or IMU sensor data) at the positions of the devices.

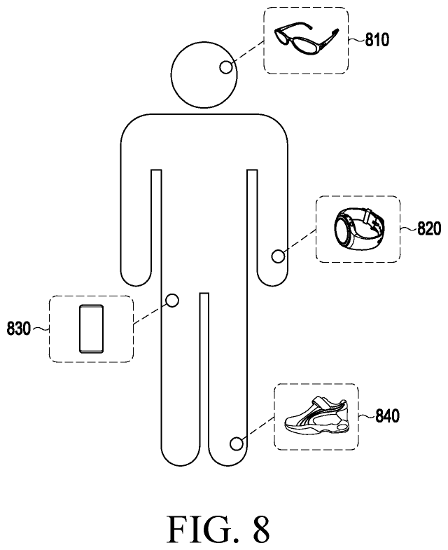

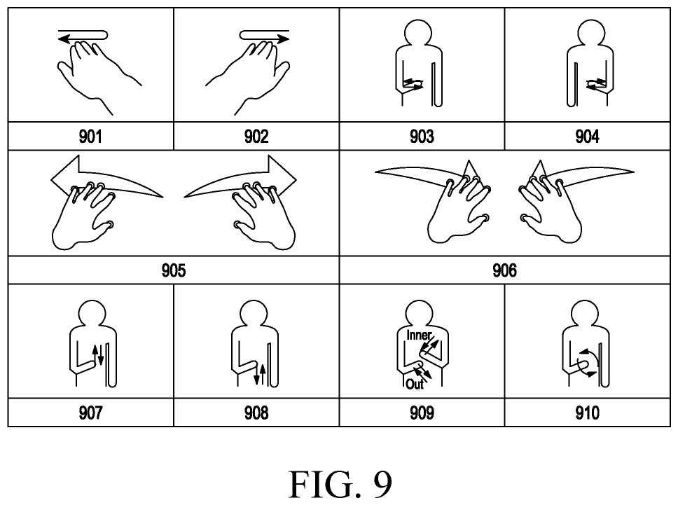

FIG. 9 illustrates various examples of a user gesture which can be identified through a BAN supporting UWB communication according to an embodiment of the disclosure.

The embodiment of FIG. 9 may be examples of user gestures identified using data acquired through, for example, a VR device and at least one peripheral device worn on the wrist or finger of the user. The acquired data may include data (e.g., TWR ranging result data (e.g., ToF or data of the distance between two devices), AoA data (e.g., AoA azimuth and/or AoA elevation), and/or CIR data) acquired through UWB ranging between the VR device and each peripheral device and sensor data (e.g., IMU sensor data) acquired from each of the VR device and each peripheral device. In the disclosure, data acquired through UWB ranging may be referred to as UWB data or UWB ranging data.

For example, as illustrated in FIG. 9, a swipe-right (right hand) gesture 901, a swipe-left (left hand) gesture 902, a right (right hand) gesture 903, a left (left hand) gesture 904, a zoom-in (both hand) gesture 905, a zoom-out (both hand) gesture 906, an up (right hand) gesture 907, a down (right hand) gesture 908, a boxing (both hand) gesture 909, and/or a circle (right hand) gesture 910 may be identified as a user gesture.

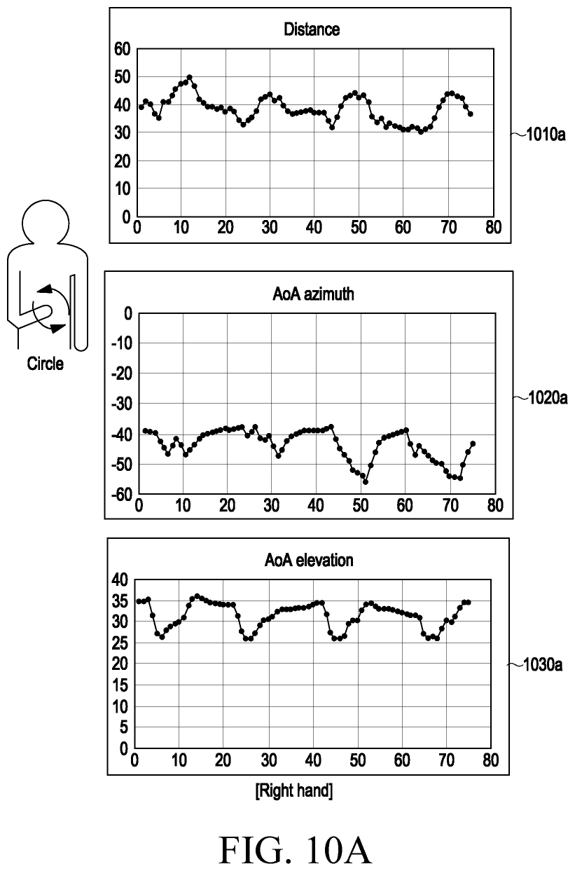

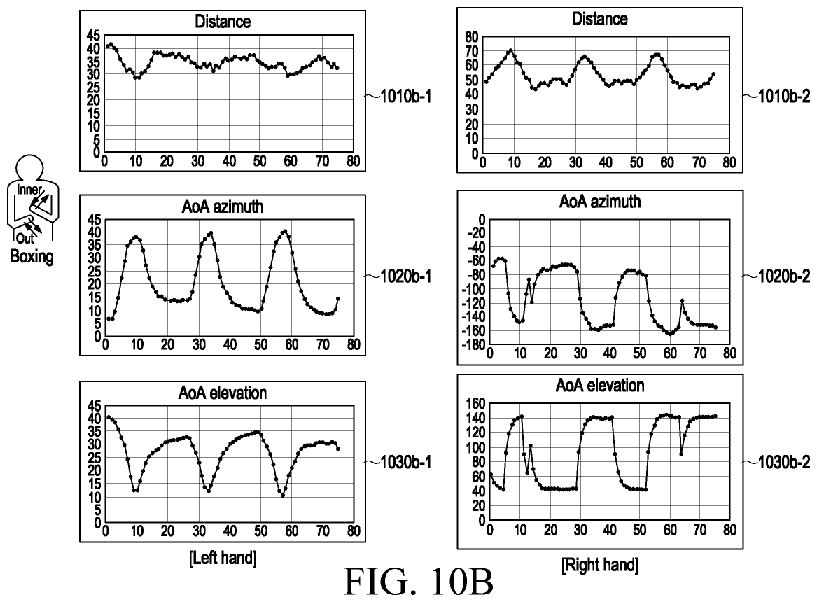

FIG. 10A illustrates an example of ranging data and AoA data indicating characteristics of a circle gesture according to an embodiment of the disclosure.

It is assumed that data acquired in the embodiment of FIG. 10A acquired when a user wearing a VR device repeatedly takes a circle gesture with a right hand on which a peripheral device is worn. The circle gesture in FIG. 10A may be, for example, the circle (right hand) gesture 910 of FIG. 9.

Referring to FIG. 10A, ranging data indicating the distance acquired through TWR between the VR device and the peripheral device on the right hand may correspond to data 1010a. As an embodiment, the ranging data may be acquired by the VR device and/or the peripheral device.

In addition, AoA azimuth data acquired based on a signal for TWR or OWR between the VR device and the peripheral device on the right hand may correspond to data 1020a. As an embodiment, the AoA azimuth data may be acquired by the VR device and/or the peripheral device.

In addition, AoA elevation data acquired based on a signal for TWR or OWR between the VR device and the peripheral device on the right hand may correspond to data 1030a. As an embodiment, the AoA elevation data may be acquired by the VR device and/or the peripheral device.

FIG. 10B illustrates an example of ranging data and AoA data indicating characteristics of a boxing gesture according to an embodiment of the disclosure.

It is assumed that data acquired in the embodiment of FIG. 10A is acquired when a user wearing a VR device repeatedly takes a boxing gesture with both hands on which peripheral devices are worn, respectively. The boxing gesture of FIG. 10B may be, for example, the boxing (both hand) gesture 909 of FIG. 9.

Referring to FIG. 10B, first ranging data indicating the distance between the VR device and the peripheral device on the left hand may correspond to data 1010b-1. Second ranging data indicating the distance acquired through TWR between the VR device and the peripheral device on the right hand may correspond to data 1010b-2. As an embodiment, the ranging data may be acquired by the VR device and/or the respective peripheral devices.

In addition, first AoA azimuth data measured based on a signal for TWR or OWR between the VR device and the peripheral device on the left hand may correspond to data 1020b-1. Second AoA azimuth data measured based on a signal for TWR or OWR between the VR device and the peripheral device on the right hand may correspond to data 1020b-1. As an embodiment, the AoA azimuth data may be acquired by the VR device and/or the respective peripheral devices.

In addition, first AoA elevation data measured based on a signal for TWR or OWR between the VR device and the peripheral device on the left hand may correspond to data 1030b-1. Second AoA elevation data measured based on a signal for TWR or OWR between the VR device and the peripheral device on the right hand may correspond to data 1030b-2. As an embodiment, the AoA elevation data may be acquired by the VR device and/or the respective peripheral devices.

As illustrated in FIGS. 10A and 10B, the ranging data and the AoA data acquired through UWB ranging may have different characteristics by the user's gesture. Accordingly, the ranging data and the AoA data may be used to identify the user's gesture. In addition. CIR data acquired through the UWB ranging (e.g., TWR or OWR) may be additionally used to identify the user's gesture.

When the ranging data. AoA data, and/or CIR data acquired through the UWB ranging are used together with the sensing data (e.g., sensing data of an IMU sensor), the accuracy of recognition of the user's gesture can be further increased.

Hereinafter, a method for identifying (or detecting) the user's gesture by using data (UWB data) acquired through UWB ranging and sensing data is described.

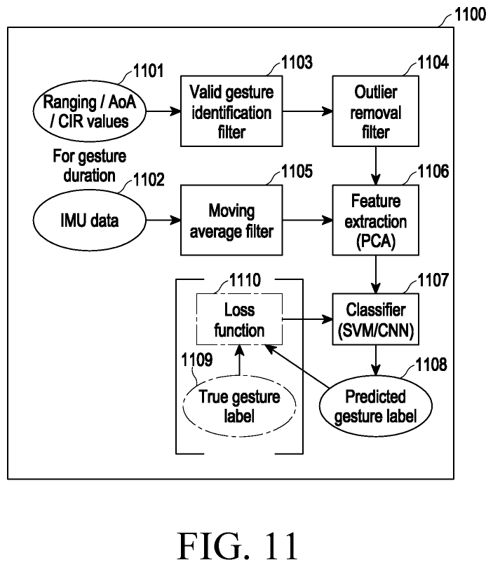

FIG. 11 illustrates a configuration of an electronic device including a model of classifying a user gesture by using data acquired through UWB ranging and sensing data according to an embodiment of the disclosure.

In the embodiment of FIG. 11, an electronic device 1100 may be an electronic device (e.g., a remote server) for training a model by using training data, an electronic device (e.g., a remote server or a user equipment) for performing initial fine-tunning for a model trained using tuning data, or an electronic device (e.g., a user equipment) for classifying a ground truth user gesture through a model trained using actual data or an initially fine-tuned model.

In the disclosure, a procedure of training a model by using training data may be referred to as a model training procedure or a training procedure. The training procedure may include acquiring a predicted value (e.g., a predicted label) by using training data having a known ground truth value (e.g., ground truth label), obtaining a loss function based on the predicted value and the ground truth value, and updating, based on the obtained loss function, parameters for a model (e.g., updating parameters for a model to reduce loss).

In the disclosure, a procedure of performing initial fine-tuning for a model trained using tuning data may be referred to as an initial fine-tuning procedure or a fine-tuning procedure. The initial fine-tuning procedure may be a procedure for when a new user uses a pretrained model, tuning the trained model to a model optimized for the corresponding user. This is for increasing the accuracy of gesture classification through the tuning to the model optimized to the corresponding user since device characteristics, gesture characteristics, and the like may minutely differ from each other for each user. Similar to the training procedure, the initial fine-tuning procedure may include acquiring a predicted value (e.g., prediction label) by using tuning data having a known ground truth value (e.g., ground truth label), obtaining a loss function based on the predicted value and the ground truth value, and tuning, based on the obtained loss function, parameters for a model (e.g., tuning parameters for a model to reduce loss).

In the disclosure, a procedure of classifying an actual user gesture through the trained model or the initially fine-tuned model by using actual data may be referred to as an implementation procedure, an actual use procedure, or an actual classification procedure. In a case of the actual use procedure, unlike the training procedure or the initial fine-tuning procedure, it is not necessary to perform obtaining, based on the predicted value and the ground truth value, a loss function and tuning (or updating) parameters for a model. That is, in the actual use procedure, the training or fine-tuning of a model is not necessary to be performed.

As an embodiment, the training procedure and the initial fine-tuning procedure may be performed by different electronic devices. For example, the training procedure may be performed by a remote server, and the initial fine-tuning procedure for the trained model may be performed by a user equipment (e.g., a VR device). Alternatively, the training procedure and the initial fine-tuning procedure may be performed by the same electronic device. For example, both the training procedure and the initial fine-tuning procedure may be performed by the remote server.

As an embodiment, the model may be a deep learning-based model (classifier) or a machine learning-based model (classifier).

Referring to FIG. 11, the electronic device 1100 may include a first input unit 1101, a second input unit 1102, a first filter 1103, a second filter 1104, a third filter 1105, a feature extraction unit 1106, a classifier 1107, a predicted gesture label identification unit 1108, a ground truth gesture label identification unit 1109, and/or a loss function unit 1110. According to an embodiment, the electronic device 1100 may not include some elements, or may further include additional elements. In addition, multiple elements may be merged into one element.

The operations until classifying corresponding input data through a model (classifier) may be all the same in the training procedure, initial fine-tuning procedure, and actual use procedure. That is, the first input unit 1101, the second input unit 1102, the first filter 1103, the second filter 1104, the third filter 1105, the feature extraction unit 1106, the classifier 1107, and the predicted gesture label identification unit 1108 may perform the same function in the training procedure, initial fine-tuning procedure, and actual use procedure.

Hereinafter, each function of the electronic device 1100 is described with reference to FIG. 11.

The first input unit 1101 may identify UWB data collected for a pre-specified gesture period, as input data (first input data).

In a case of the training procedure, the first input data may be UWB data corresponding to the gesture period among pieces of pre-collected training data. In a case of the initial fine-tuning procedure, the first input data may be UWB data corresponding to the gesture period among pieces of tuning data collected for an initial fine-tuning period. In a case of the actual use procedure, the first input data may be real-time UWB data collected for the gesture period.

As an embodiment, UWB ranging data may include ranging data (ranging result data), AoA data, and/or CIR data. The ranging data, the AoA data, and the CIR data may be processed in parallel to one another, and may be input to the feature extraction unit 1106 or the classifier 1107, as input data. For example, each of the ranging data, the AoA data, and the CIR data may be input to the feature extraction unit 1106 or the classifier 1107, as input data of the feature extraction unit 1106 or the classifier 1107, through individual processing of the first filter 1103 and the second filter 1104.

The second input unit 1102 may identify IMU sensor data collected for a collection of the first input data by the first input unit 1101 may be identical to the gesture period for collection of the second input data by the second input unit 1102.

In a case of the training procedure, the second input data may be IMU sensor data corresponding to the gesture period among pieces of pre-collected training data. In a case of the initial fine-tuning procedure, the first input data may be IMU sensor data corresponding to the gesture period among pieces of tuning data collected for an initial fine-tuning period. In a case of the actual use procedure, the first input data may be real-time IMU sensor data collected for the gesture period.

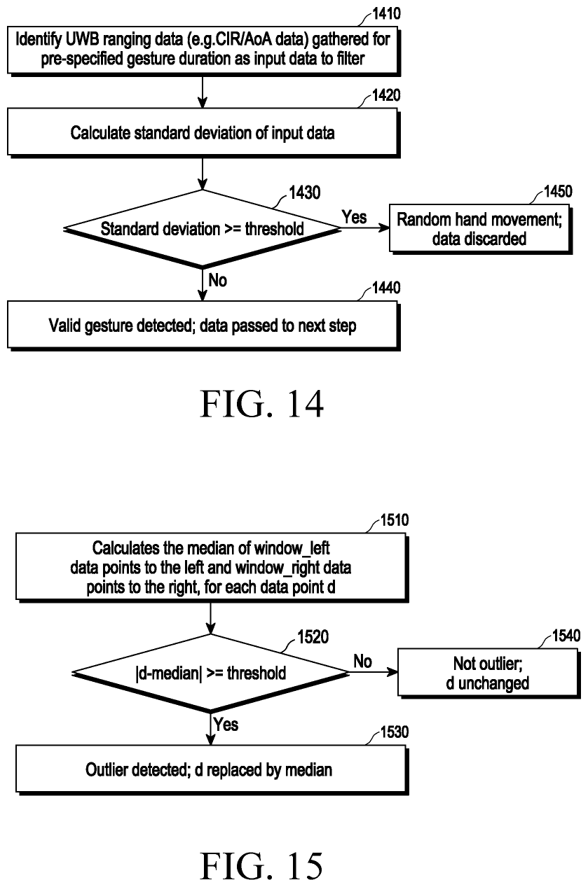

The first filter 1103 may be applied to the first input data to distinguish between a valid gesture and a random hand movement. The first filter 1103 may be a valid gesture identification filter. As an embodiment, the valid gesture identification filter may use standard deviation of corresponding input data to distinguish between the valid gesture and the random hand movement. For example, the valid gesture identification filter may use standard deviation of AoA azimuth data collected to filter AoA azimuth data, and use standard deviation of AoA elevation data collected to filter AoA elevation data. The valid gesture identification filter may standard deviation of CIR data collected to filter CIR data. An example of the operation of the first filter 1103 is described below with reference to FIG. 14.

As an embodiment, the first filter 1103 may be applied only to a part of the first input data. For example, the first filter 1103 may be applied only to AoA data and CIR data of the first input data.

The second filter 1104 may be applied to the first input data to remove an outlier. The second filter 1104 may be an outlier removal filter. As an embodiment, the outlier removal filter may determine an outlier from the first input data (or first input data to which the first filter 1103 is applied), and substitute the determined outlier for a median of surrounding values. Accordingly, the outlier can be removed. An example of the operation of the second filter 1104 is described below with reference to FIG. 15.

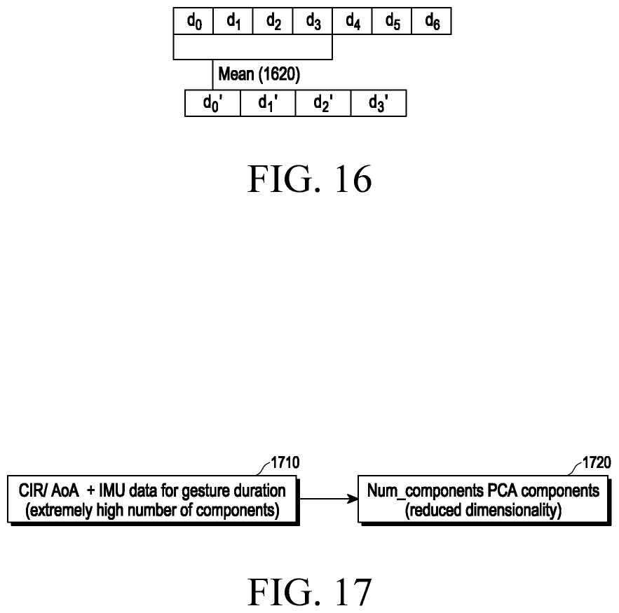

The third filter 1105 may be applied to the second input data to reduce noise in the second input data. The third filter 1105 may be a moving average filter. The third filter 1105 may have a pre-designated window size to filter the second input data. An example of the operation of the third filter 1105 is described below with reference to FIG. 16.

The feature extraction unit 1106 may be used for optimal feature extraction to reduce data dimensionality and overfitting. The feature extraction unit 1106 may use principal component analysis (PCA) for optimal feature extraction.

The feature extraction unit 1106 may be applied to the first input data obtained through filtering by the second filter 1104 and the second input data obtained through filtering by the third filter 1105. For example, the feature extraction unit 1106 extract ranging data from which the outlier has been removed, AoA azimuth data from which the outlier has been removed. AoA elevation data from which the outlier has been removed, and IMU data to which the moving average filter is applied, so as to extract a feature (e.g., PCA-based feature).

As an embodiment, when the classifier 1107 is a convolutional neural network (CNN)-based classifier, the feature extraction unit 1106 may be omitted. For example, in a case of the CNN-based classifier, the extracted feature (e.g., PCA-based feature) is not required, and raw data (e.g., AoA data from which the outlier has been removed and IMU data to which the moving average filter is applied) can be directly used for gesture label prediction.

As an embodiment, when the classifier 1107 is a support vector machine (SVM)-based classifier, the feature extraction unit 1106 may be used. For example, in a case of the SVM-based classifier, the extracted feature (e.g., PCA-based feature) can be used for gesture label prediction. An example of the operation of the feature extraction unit 1106 is described below with reference to FIG. 17.

The classifier 1107 may classify the input data into multiple output labels (e.g., gesture labels).

The input data of the classifier 1107 may be the first input data and the second input data to which the feature extraction unit 1106 is applied. For example, the input data of the classifier 1107 may include PCA-based feature data output from the feature extraction unit 1106.

The input data of the classifier 1107 may be the first input data and the second input data to which the feature extraction unit 1106 is not applied. For example, the input data of the classifier 1107 may include ranging data from which the outlier has been removed, AoA azimuth data from which the outlier has been removed, AoA elevation data from which the outlier has been removed, and/or IMU data to which the moving average filter is applied.

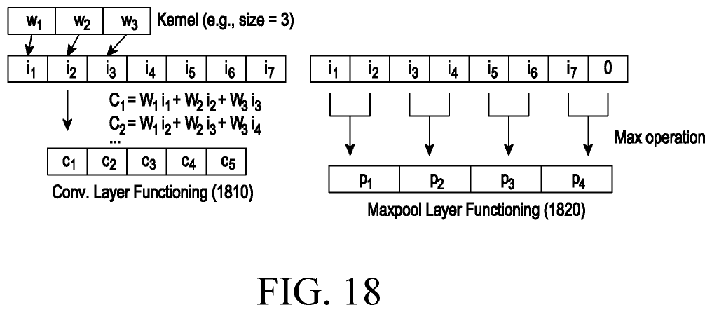

As an embodiment, the classifier 1107 may be a classifier using a machine learning algorithm. For example, the classifier 1107 may be the SVM-based classifier (SVM classifier). The SVM classifier may have a faster speed than the CNN classifier, and may be used instead of the CNN classifier when a processing speed is important. As an embodiment, the classifier 1107 may be a classifier using a deep learning algorithm. For example, the classifier 1107 may be the CNN-based classifier (CNN classifier). The CNN classifier may have a better recognition rate than the SVM classifier, and may be used instead of the SVM classifier when a recognition performance is important. An example of the operation of the CNN-based classifier 1107 is described below with reference to FIG. 18.

The predicted gesture label identification unit 1108 may identify output label data (predicted gesture label data) of the classifier 1107. For example, when a classifier 1207b is configured to have two gesture labels (e.g., two gesture label corresponding to the boxing gesture and the circle gesture, respectively), as an output label, predicted gesture label data (gesture prediction data) may include a probability that a gesture for the input data is a gesture (e.g., the boxing gesture) corresponding to a first gesture label and a probability that a gesture for the input data is a gesture (e.g., the circle gesture) corresponding to a second gesture label. In the disclosure, the output label data may be referred to as predicted gesture label data, gesture prediction data, or prediction data.

In a case of the actual use procedure, the electronic device 1100 may determine a final gesture by using the identified predicted gesture label data. For example, the electronic device 1100 may determine, as a final gesture, a gesture corresponding a gesture label having the highest probability. Accordingly, in a case of the actual use procedure, the electronic device 1100 may not use the ground truth gesture label identification unit 1109 and the loss function unit 1110.

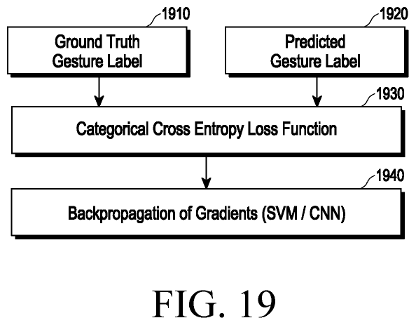

In a case of the training procedure and the initial fine-tuning procedure, the electronic device 1100 may further perform subsequent operations. That is, in a case of the training procedure and the initial fine-tuning procedure, the electronic device 1100 may use the ground truth gesture label identification unit 1109 and the loss function unit 1110. An example of the operation of the loss function unit 1110 is described below with reference to FIG. 19.

For example, in a case of the training procedure and the initial fine-tuning procedure, the predicted gesture label identification unit 1108 may input data of the identified predicted gesture label to the loss function unit 1110. The ground truth gesture label identification unit 1109 may identify a ground truth gesture label corresponding to the input data, and input data of the identified ground truth gesture label to the loss function unit 1110. The ground truth gesture label data may include, for example, information (e.g., probability) on a gesture label corresponding to the ground truth gesture of the input data. The loss function unit 1110 may obtain a loss function based on predicted gesture label data (predicted value) and ground truth gesture label data (ground truth value), and the loss function may be backpropagated to update parameters of the classifier. For example, the loss function unit 1110 may obtain a loss function (e.g., categorical cross entropy loss function) based on loss (e.g., error) of the predicted gesture label data (predicted value) and the ground truth gesture label data (ground truth value), and may update parameters of the classifier to reduce loss by backpropagating the loss function.

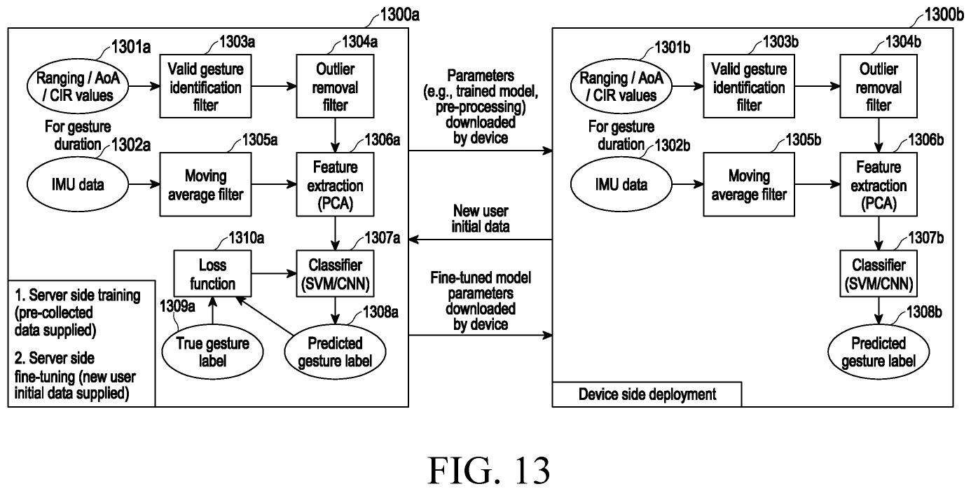

As an embodiment, when the initial fine-tuning procedure is performed by the remote server performing the model procedure, a user equipment (e.g., VR device) may not include the ground truth gesture label identification unit 1109 and the loss function unit 1110, or may include the same but may not activate the same. In this case, the initial fine-tuning procedure may be performed by the remote server for training the model, and parameters for the model tuned through the fine-tuning procedure may be downloaded again and used by the user equipment. To this end, the user equipment may transfer tuning data collected for the initial fine-tuning period to the remote server for training the model, and the transferred tuning data may be used in the fine-tuning procedure of the remote server. This embodiment is advantageous in that required computing power of the user equipment can be reduced. An example of the embodiment may be as in FIG. 13.

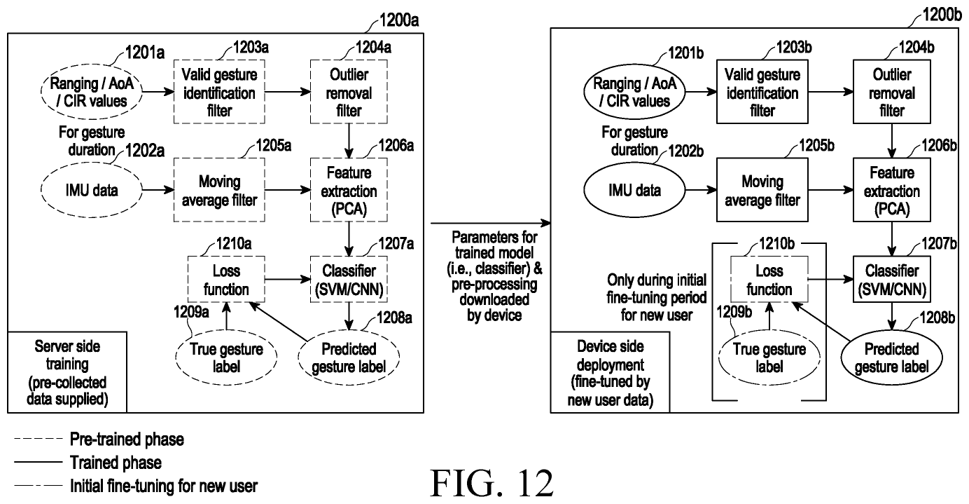

As an embodiment, when the initial fine-tuning procedure is performed by the user equipment (e.g., VR device), the user equipment for performing the actual use procedure needs to include the ground truth gesture label identification unit 1109 and the loss function unit 1110. In this case, the user equipment may perform the initial fine-tuning procedure by using tuning data collected for the initial fine-tuning period by the user equipment itself, and may use, in the actual use procedure, parameter for the model tuned through the initial fine-tuning procedure. In a case of this embodiment, user privacy can be protected without exposure of the tuning data collected by the user equipment. An example of this embodiment may be as in FIG. 12.

Hereinafter, various embodiments of a method for training a model (classifier) for classifying a gesture, and using the trained model are described.

FIG. 12 illustrates an example of a method for training a model for classifying a gesture, and using the trained model according to an embodiment of the disclosure.

In the embodiment of FIG. 12, a training procedure and an initial fine-tuning procedure for a trained model may be performed by different electronic devices. For example, as illustrated above, the training procedure may be performed by a remote server 1200a, and the initial fine-tuning procedure may be performed by a user equipment (e.g., VR device) 1200b.

Referring to FIG. 12, the remote server 1200a may include a first input unit 1201a, a second input unit 1202a, a first filter 1203a, a second filter 1204a, a third filter 1205a, a feature extraction unit 1206a, a classifier 1207a, a predicted gesture label identification unit 1208a, a ground truth gesture label identification unit 1209a, and/or a loss function unit 1210a. According to an embodiment, the remote server 1200a may not include some elements, and may further include an additional element. In addition, multiple elements may be merged into one element.

The functions of the first input unit 1201a, the second input unit 1202a, the first filter 1203a, the second filter 1204a, the third filter 1205a, the feature extraction unit 1206a, the classifier 1207a, the predicted gesture label identification unit 1208a, the ground truth gesture label identification unit 1209a, and the loss function unit 1210a of the remote server 1200a may be identical to those of the first input unit 1101, the second input unit 1102, the first filter 1103, the second filter 1104, the third filter 1105, the feature extraction unit 1106, the classifier 1107, the predicted gesture label identification unit 1108, the actuation gesture label identification unit 1109, and the loss function unit 1110 of the electronic device 1100 described above. Accordingly, as long as there is no mutual contradiction, to describe the corresponding element of FIG. 12, a description of the corresponding element of FIG. 11 may be referred to.

Hereinafter, a model training procedure (training procedure) is described through the operation of each element of the remote server 1200a.

The training procedure may be performed using pre-collected training data. The training data may include UWB data and IMU sensor data. The UWB data may include ranging data (ranging result data), AoA data, and/or CIR data.

Referring to FIG. 12, the first input unit 1201a may identify, as input data (first input data), UWB data collected for a pre-specified gesture period. For example, in a case a training procedure, the first input data may be UWB data corresponding to the gesture period among pieces of pre-collected training data.

As an embodiment, the UWB data may include ranging data, AoA data, and/or CIR data. The ranging data, the AoA data, and the CIR data may be processed in parallel to one another, and may be input to the feature extraction unit 1206a or the classifier 1207a, as input data. For example, each of the ranging data, the AoA data, and the CIR data may be input as input data of the feature extraction unit 1206a or the classifier 1207a through individual processing of the first filter 1203a and the second filter 1204a.

The second input unit 1202a may identify IMU sensor data collected for a pre-specified gesture period, as input data (second input data). For example, in a case of the training procedure, the second input data may be IMU sensor data corresponding to the gesture period among pieces of pre-collected training data. The gesture period for collection of the first input data by the first input data collection unit 1201a may be identical to the gesture period for collection of the second input data by the second input data collection unit 1202a.

The first filter 1203a may be applied to the first input data to distinguish between a valid gesture and a random hand movement. The first filter 1203a may be a valid gesture identification filter. As an embodiment, the valid gesture identification filter may use standard deviation of corresponding input data to distinguish between the valid gesture and the random hand movement. For example, the valid gesture identification filter may use standard deviation of AoA azimuth data collected to filter AoA azimuth data, and use standard deviation of AoA elevation data collected to filter AoA elevation data. The valid gesture identification filter may standard deviation of CIR data collected to filter CIR data.

As an embodiment, the first filter 1203a may be applied only to a part of the first input data. For example, the first filter 1203a may be applied only to AoA data and CIR data of the first input data.

The second filter 1204a may be applied to the first input data to remove an outlier. The second filter 1204a may be an outlier removal filter. As an embodiment, the outlier removal filter may determine an outlier from the first input data (or first input data to which the first filter 1203a is applied), and substitute the determined outlier for a median of surrounding values. Accordingly, the outlier can be removed.

The third filter 1205a may be applied to the second input data to reduce noise in the second input data. The third filter 1205a may be a moving average filter. The third filter 1205a may have a pre-designated window size to filter the second input data.

The feature extraction unit 1206a may be used for optimal feature extraction to reduce data dimensionality and overfitting. The feature extraction unit 1206a may use principal component analysis (PCA) for optimal feature extraction.

The feature extraction unit 1206a may be applied to the first input data obtained through filtering by the second filter 1204a and the second input data obtained through filtering by the third filter 1205a. For example, the feature extraction unit 1206a may extract ranging data from which the outlier has been removed, AoA azimuth data from which the outlier has been removed, AoA elevation data from which the outlier has been removed, and IMU data to which the moving average filter is applied, so as to extract a feature (e.g., PCA-based feature).

As an embodiment, when the classifier 1207a is a convolutional neural network (CNN)-based classifier, the feature extraction unit 1206a may be omitted. For example, in a case of the CNN-based classifier, the extracted feature (e.g., PCA-based feature) is not required, and raw data (e.g., AoA data from which the outlier has been removed and IMU data to which the moving average filter is applied) can be directly used for gesture label prediction.

As an embodiment, when the classifier 1207a is a support vector machine (SVM)-based classifier, the feature extraction unit 1206a may be used. For example, in a case of the SVM-based classifier, the extracted feature (e.g., PCA-based feature) can be used for gesture label prediction.

The classifier 1207a may classify the input data into multiple output labels (e.g., gesture labels).

The input data of the classifier 1207a may be the first input data and the second input data to which the feature extraction unit 1206a is applied. For example, the input data of the classifier 1207a may include PCA-based feature data output from the feature extraction unit 1206a.

The input data of the classifier 1207a may be the first input data and the second input data to which the feature extraction unit 1206a is not applied. For example, the input data of the classifier 1207a may include ranging data from which the outlier has been removed, AoA azimuth data from which the outlier has been removed, AoA elevation data from which the outlier has been removed, and/or IMU data to which the moving average filter is applied.

As an embodiment, the classifier 1207a may classify the input data into two or more gesture labels (predicted gesture labels). For example, when the classifier 1207a is configured to have two gesture labels (e.g., two gesture labels corresponding to a boxing gesture and a circle gesture, respectively) as an output label, the classifier 1207a may output a probability that a probability that a gesture for the input data is a gesture (e.g., the boxing gesture) corresponding to a first gesture label and a probability that a gesture for the input data is a gesture (e.g., the circle gesture) corresponding to a second gesture label.

As an embodiment, the classifier 1207a may be a classifier using a machine learning algorithm. For example, the classifier 1207a may be an SVM-based classifier.

As an embodiment, the classifier 1207a may be a classifier using a deep learning algorithm. For example, the classifier 1207a may be a CNN-based classifier.

The predicted gesture label identification unit 1208a may identify output label data (predicted gesture label data) of the classifier 1207a, and may transfer the identified predicted gesture label data to the loss function unit 1207a. For example, when the classifier 1207a is configured to have two gesture labels (e.g., two gesture label corresponding to the boxing gesture and the circle gesture, respectively), as an output label, predicted gesture label data may include a probability that a gesture for the input data is a gesture (e.g., the boxing gesture) corresponding to a first gesture label and a probability that a gesture for the input data is a gesture (e.g., the circle gesture) corresponding to a second gesture label.

The ground truth gesture label identification unit 1209a may identify a ground truth gesture label corresponding to the input data, and input data of the identified ground truth gesture label to the loss function unit 1210a. The ground truth gesture label data may include, for example, information (e.g., probability) on a gesture label corresponding to the ground truth gesture of the input data.

The loss function unit 1210a may obtain a loss function based on predicted gesture label data (predicted value) and ground truth gesture label data (ground truth value), and the loss function may be backpropagated to update parameters of the classifier.

The model training procedure may be repeatedly performed for pre-collected training data. Optimal parameters for the model can be determined through the training process. The determined parameters and/or information on the trained model may be downloaded to a user equipment and used for gesture classification by the user equipment.

Hereinafter, through the operation of each element of a user equipment 1200b, an initial fine-tuning procedure for the trained model and a gesture classification procedure (actual use procedure) using the fine-tuned trained model are described.

The initial fine-tuning procedure may be performed using data (tuning data) collected for a pre-specified initial fine-tuning period. The tuning data may include UWB data and IMU sensor data collected for the pre-specified fine-tuning period. The UWB data may include ranging data (ranging result data), AoA data, and/or CIR data.

The actual use procedure may be performed using actual data (e.g., data collected in real time). The actual data may include UWB data and IMU sensor data collected in real time. The UWB data may include ranging data (ranging result data), AoA data, and/or CIR data.

Referring to FIG. 12, the user equipment 1200b may include a first input unit 1201b, a second input unit 1202b, a first filter 1203b, a second filter 1204b, a third filter 1205b, a feature extraction unit 1206b, a classifier 1207b, a predicted gesture label identification unit 1208b, a ground truth gesture label identification unit 1209b, and/or a loss function unit 1210b. According to an embodiment, the user equipment 1200b may not include some elements, and may further include an additional element. In addition, multiple elements may be merged into one element.

The functions of the first input unit 1201b, the second input unit 1202b, the first filter 1203b, the second filter 1204b, the third filter 1205b, the feature extraction unit 1206b, the classifier 1207b, the predicted gesture label identification unit 1208b, the ground truth gesture label identification unit 1209b, and the loss function unit 1210b of the user equipment 1200b may be identical or similar to those of the first input unit 1101, the second input unit 1102, the first filter 1103, the second filter 1104, the third filter 1105, the feature extraction unit 1106, the classifier 1107, the predicted gesture label identification unit 1108, the actuation gesture label identification unit 1109, and the loss function unit 1110 of the electronic device 1100 described in FIG. 11 above. Accordingly, as long as there is no mutual contradiction, to describe the corresponding element of FIG. 12, a description of the corresponding element of FIG. 11 may be referred to.

The first input unit 1201b may identify, as input data (first input data), UWB ranging data collected for a pre-specified gesture period.

For example, in a case an initial fine-tuning procedure, the first input data may be UWB data corresponding to the gesture period among pieces of tuning data collected for the initial fine-tuning period. In a case of an actual use procedure, the first input data may be real-time UWB data collected for the gesture period.

As an embodiment, the UWB data may include ranging data. AoA data, and/or CIR data. The ranging data, the AoA data, and the CIR data may be processed in parallel to one another, and may be input to the feature extraction unit 1206b or the classifier 1207b, as input data. For example, each of the ranging data, the AoA data, and the CIR data may be input as input data of the feature extraction unit 1206b or the classifier 1207b through individual processing of the first filter 1203b and the second filter 1204b.

The second input unit 1202b may identify IMU sensor data collected for a collection of the first input data by the first input unit 1101 may be identical to the gesture period for collection of the second input data by the second input unit 1102.

In a case of the initial fine-tuning procedure, the first input data may be IMU sensor data corresponding to the gesture period among piece of tuning data collected for the initial fine-tuning period. In a case of the actual use procedure, the first input data may be real-time IMU sensor data collected for the gesture period.

The first filter 1203b may be applied to the first input data to distinguish between a valid gesture and a random hand movement. The first filter 1203b may be a valid gesture identification filter. As an embodiment, the valid gesture identification filter may use standard deviation of corresponding input data to distinguish between the valid gesture and the random hand movement. For example, the valid gesture identification filter may use standard deviation of AoA azimuth data collected to filter AoA azimuth data, and use standard deviation of AoA elevation data collected to filter AoA elevation data. The valid gesture identification filter may standard deviation of CIR data collected to filter CIR data.

As an embodiment, the first filter 1203b may be applied only to a part of the first input data. For example, the first filter 1203b may be applied only to AoA data and CIR data of the first input data.

The second filter 1204b may be applied to the first input data to remove an outlier. The second filter 1204b may be an outlier removal filter. As an embodiment, the outlier removal filter may determine an outlier from the first input data (or first input data to which the first filter 1203b is applied), and substitute the determined outlier for a median of surrounding values. Accordingly, the outlier can be removed.

The third filter 1205b may be applied to the second input data to reduce noise in the second input data. The third filter 1205a may be a moving average filter. The third filter 1205b may have a pre-designated window size to filter the second input data.

The feature extraction unit 1206b may be used for optimal feature extraction to reduce data dimensionality and overfitting. The feature extraction unit 1206b may use principal component analysis (PCA) for optimal feature extraction.

The feature extraction unit 1206b may be applied to the first input data obtained through filtering by the second filter 1204b and the second input data obtained through filtering by the third filter 1205b. For example, the feature extraction unit 1206b may extract ranging data from which the outlier has been removed. AoA azimuth data from which the outlier has been removed. AoA elevation data from which the outlier has been removed, and IMU data to which the moving average filter is applied, so as to extract a feature (e.g., PCA-based feature).

As an embodiment, when the classifier 1207b is a convolutional neural network (CNN)-based classifier, the feature extraction unit 1206b may be omitted. For example, in a case of the CNN-based classifier, the extracted feature (e.g., PCA-based feature) is not required, and raw data (e.g., AoA data from which the outlier has been removed and IMU data to which the moving average filter is applied) can be directly used for gesture label prediction.

As an embodiment, when the classifier 1207b is a support vector machine (SVM)-based classifier, the feature extraction unit 1206b may be used. For example, in a case of the SVM-based classifier, the extracted feature (e.g., PCA-based feature) can be used for gesture label prediction.

The classifier 1207b may classify the input data into multiple output labels (e.g., gesture labels).

The input data of the classifier 1207b may be the first input data and the second input data to which the feature extraction unit 1206b is applied. For example, the input data of the classifier 1207b may include PCA-based feature data output from the feature extraction unit 1206b.

The input data of the classifier 1207b may be the first input data and the second input data to which the feature extraction unit 1206b is not applied. For example, the input data of the classifier 1207b may include ranging data from which the outlier has been removed, AoA azimuth data from which the outlier has been removed, AoA elevation data from which the outlier has been removed, and/or IMU data to which the moving average filter is applied.

As an embodiment, the classifier 1207b may classify the input data into two or more gesture labels (predicted gesture labels). For example, when the classifier 1207b is configured to have two gesture labels (e.g., two gesture labels corresponding to a boxing gesture and a circle gesture, respectively) as an output label, the classifier 1207b may output a probability that a probability that a gesture for the input data is a gesture (e.g., the boxing gesture) corresponding to a first gesture label and a probability that a gesture for the input data is a gesture (e.g., the circle gesture) corresponding to a second gesture label.

As an embodiment, the classifier 1207b may be a classifier using a machine learning algorithm. For example, the classifier 1207b may be an SVM-based classifier.

As an embodiment, the classifier 1207b may be a classifier using a deep learning algorithm. For example, the classifier 1207b may be a CNN-based classifier.

The predicted gesture label identification unit 1208b may identify output label data (predicted gesture label data) of the classifier 1207b. For example, when the classifier 1207b is configured to have two gesture labels (e.g., two gesture label corresponding to the boxing gesture and the circle gesture, respectively), as an output label, predicted gesture label data may include a probability that a gesture for the input data is a gesture (e.g., the boxing gesture) corresponding to a first gesture label and a probability that a gesture for the input data is a gesture (e.g., the circle gesture) corresponding to a second gesture label.

In a case of the actual use procedure, the user equipment 1200b may determine a final gesture by using the identified predicted gesture label data. For example, the electronic device 1200b may determine, as a final gesture, the identified predicted gesture label data. For example, the electronic device 1200b may determine, as a final gesture, the gesture corresponding to a gesture label having the highest probability. Accordingly, in a case of the actual use procedure, the user equipment 1200b may not use the ground truth gesture label identification unit 1209b and the loss function unit 1210b.

In a case of the initial fine-tuning procedure, the user equipment 1200b may further perform subsequent operations. That is, in a case of the fine-tuning procedure, the user equipment 1200b may use the ground truth gesture label identification unit 1209b and the loss function unit 1210b.

For example, in a case of the initial fine-tuning procedure, the predicted gesture label identification unit 1208b may input data of the identified predicted gesture label to the loss function unit 1210b. In addition, the ground truth gesture label identification unit 1209b may identify a ground truth gesture label corresponding to the input data, and input data of the identified ground truth gesture label to the loss function unit 1210b. The ground truth gesture label data may include, for example, information (e.g., probability) on a gesture label corresponding to the ground truth gesture of the input data. In addition, the loss function unit 1210b may obtain a loss function (e.g., categorical cross entropy loss function) based on loss (e.g., error) of the predicted gesture label data (predicted value) and the ground truth gesture label data (ground truth value), and may adjust parameters of the classifier to reduce loss by backpropagating the loss function.

The fine-tuning procedure may be performed for all the pre-collected tuning data. Through the fine-tuning procedure, adjusted parameters for a model optimized for a new user can be acquired.

FIG. 13 illustrates another example of a method for training a model for classifying a gesture, and using the trained model according to an embodiment of the disclosure.

In the embodiment of FIG. 13, a training procedure and an initial fine-tuning procedure for the trained model may be performed by the same electronic device. For example, as illustrated, the training procedure and the initial fine-tuning procedure may be performed by a remote server 1300a.

Referring to FIG. 13, the remote server 1300a may include a first input unit 1301a, a second input unit 1302a, a first filter 1303a, a second filter 1304a, a third filter 1305a, a feature extraction unit 1306a, a classifier 1307a, a predicted gesture label identification unit 1308a, a ground truth gesture label identification unit 1309a, and/or a loss function unit 1310a. According to an embodiment, the remote server 1300a may not include some elements, and may further include an additional element. In addition, multiple elements may be merged into one element.

The functions of the first input unit 1301a, the second input unit 1302a, the first filter 1303a, the second filter 1304a, the third filter 1305a, the feature extraction unit 1306a, the classifier 1307a, the predicted gesture label identification unit 1308a, the ground truth gesture label identification unit 1309a, and the loss function unit 1310a of the remote server 1300a may be identical to those of the first input unit 1101, the second input unit 1102, the first filter 1103, the second filter 1104, the third filter 1105, the feature extraction unit 1106, the classifier 1107, the predicted gesture label identification unit 1108, the actuation gesture label identification unit 1109, and the loss function unit 1110 of the electronic device 1100 described above. Accordingly, as long as there is no mutual contradiction, to describe the corresponding element of FIG. 13a, a description of the corresponding element of FIG. 11 may be referred to.

Hereinafter, an initial fine-tuning procedure (training procedure) is described through the operation of each element of the remote server 1300a. The training procedure of the remote server 1300a is identical to the training procedure of the remote server 1200a of FIG. 12, and thus a redundant description is omitted.

The initial fine-tuning procedure may be performed using data (tuning data) collected by the user equipment 1300b for a pre-specified initial fine-tuning period. The tuning data may include UWB data and IMU sensor data collected by the user equipment 1300b for the pre-specified initial fine-tuning period. The UWB data may include ranging data (ranging result data), AoA data, and/or CIR data. The tuning data (new user initial data) collected by the user equipment 1300b may be transferred to the remote server 1300a and used by the remote server 1300a in the initial fine-tuning procedure.

To described the initial fine-tuning procedure with reference to FIG. 13, the first input unit 1301a may identify, as input data (first input data), UWB data collected for a pre-specified gesture period. For example, in a case the initial fine-tuning procedure, the first input data may be UWB data corresponding to the gesture period among pieces of tuning data for the initial fine-tuning period.

As an embodiment, the UWB ranging data may include ranging data, AoA data, and/or CIR data. The ranging data, the AoA data, and the CIR data may be processed in parallel to one another, and may be input to the feature extraction unit 1306a or the classifier 1307a, as input data. For example, each of the ranging data, the AoA data, and the CIR data may be input as input data of the feature extraction unit 1306a or the classifier 1307a through individual processing of the first filter 1303a and the second filter 1304a. The processing of the first filter 1303a and the second filter 1304a of the remote server 1300a for the corresponding input data is identical to the processing of the first filter 1203a and the second filter 1204a of the remote server 1200a, and thus a redundant description is omitted.

The second input unit 1202a may identify IMU sensor data collected for a pre-specified gesture period, as input data (second input data). For example, in a case of the training procedure, the second input data may be IMU sensor data corresponding to the gesture period among pieces of pre-collected training data. The gesture period for collection of the first input data by the first input data collection unit 1201aa may be identical to the gesture period for collection of the second input data by the second input data collection unit 1202a.

The IMU sensor data may be input as input data of the feature extraction unit 1306a or the classifier 1307a through the processing of the third filter 1305a. The processing of the third filter 1305a of the remove server 1300a for the corresponding input data is identical to the processing of the third filter 1205a of the remote server 1200a, and thus a redundant description is omitted.

The feature extraction unit 1306a may be used for optimal feature extraction to reduce data dimensionality and overfitting. The feature extraction unit 1306a may use principal component analysis (PCA) for optimal feature extraction.

The feature extraction unit 1306a may be applied to the first input data obtained through filtering by the second filter 1304a and the second input data obtained through filtering by the third filter 1305a. For example, the feature extraction unit 1306a may extract ranging data from which the outlier has been removed, AoA azimuth data from which the outlier has been removed, AoA elevation data from which the outlier has been removed, and IMU data to which the moving average filter is applied, so as to extract a feature (e.g., PCA-based feature).

As an embodiment, when the classifier 1307a is a convolutional neural network (CNN)-based classifier, the feature extraction unit 1306a may be omitted. For example, in a case of the CNN-based classifier, the extracted feature (e.g., PCA-based feature) is not required, and raw data (e.g., AoA data from which the outlier has been removed and IMU data to which the moving average filter is applied) can be directly used for gesture label prediction.

As an embodiment, when the classifier 1307a is a support vector machine (SVM)-based classifier, the feature extraction unit 1306a may be used. For example, in a case of the SVM-based classifier, the extracted feature (e.g., PCA-based feature) can be used for gesture label prediction.

The classifier 1307a may classify the input data into multiple output labels (e.g., gesture labels). The parameters for the classifier 1307a may be parameters determined through the training procedure.

The input data of the classifier 1307a may be the first input data and the second input data to which the feature extraction unit 1306a is applied. For example, the input data of the classifier 1307a may include PCA-based feature data output from the feature extraction unit 1306a.

The input data of the classifier 1307a may be the first input data and the second input data to which the feature extraction unit 1306a is not applied. For example, the input data of the classifier 1307a may include ranging data from which the outlier has been removed, AoA azimuth data from which the outlier has been removed, AoA elevation data from which the outlier has been removed, and/or IMU data to which the moving average filter is applied.

As an embodiment, the classifier 1307a may classify the input data into two or more gesture labels (predicted gesture labels). For example, when the classifier 1307a is configured to have two gesture labels (e.g., two gesture labels corresponding to a boxing gesture and a circle gesture, respectively) as an output label, the classifier 1307a may output a probability that a probability that a gesture for the input data is a gesture (e.g., the boxing gesture) corresponding to a first gesture label and a probability that a gesture for the input data is a gesture (e.g., the circle gesture) corresponding to a second gesture label.

As an embodiment, the classifier 1307a may be a classifier using a machine learning algorithm. For example, the classifier 1307a may be an SVM-based classifier.

As an embodiment, the classifier 1307a may be a classifier using a deep learning algorithm. For example, the classifier 1307a may be a CNN-based classifier.

The predicted gesture label identification unit 1308a may identify output label data (predicted gesture label data) of the classifier 1307a, and may transfer the identified predicted gesture label data to the loss function unit 1307a. For example, when the classifier 1307a is configured to have two gesture labels (e.g., two gesture label corresponding to the boxing gesture and the circle gesture, respectively), as an output label, predicted gesture label data may include a probability that a gesture for the input data is a gesture (e.g., the boxing gesture) corresponding to a first gesture label and a probability that a gesture for the input data is a gesture (e.g., the circle gesture) corresponding to a second gesture label.

The ground truth gesture label identification unit 1309a may identify a ground truth gesture label corresponding to the input data, and input data of the identified ground truth gesture label to the loss function unit 1310a. The ground truth gesture label data may include, for example, information (e.g., probability) on a gesture label corresponding to the ground truth gesture of the input data.

The loss function unit 1310a may obtain a loss function (e.g., categorical cross entropy loss function) based on loss (e.g., error) of the predicted gesture label data (predicted value) and the ground truth gesture label data (ground truth value), and may adjust parameters of the classifier to reduce loss by backpropagating the loss function.

The fine-tuning procedure may be performed for all the pre-collected tuning data. Through the fine-tuning procedure, adjusted parameters for a model optimized for a new user can be acquired. Information on the adjusted parameters may be transferred to the user equipment (e.g., downloaded by the user equipment), and used for gesture classification by the user equipment.

Hereinafter, through the operation of each element of a user equipment 1300b, a gesture classification procedure (actual use procedure) using the fine-tuned trained model is described.

The initial fine-tuning procedure may be performed using actual data (e.g., data collected in real time). The actual data may include UWB ranging data and IMU sensor data collected in real time. The UWB ranging data may include ranging data. AoA data, and/or CIR data.

Referring to FIG. 13, the user equipment 1300b may include a first input unit 1301b, a second input unit 1302b, a first filter 1303b, a second filter 1304b, a third filter 1305b, a feature extraction unit 1306b, a classifier 1307b, and/or a predicted gesture label identification unit 1308b. As an embodiment of FIG. 13, the user equipment 1300b may not include a ground truth gesture label identification unit and a loss function unit. According to an embodiment, the user equipment 1300b may not include some elements, and may further include an additional element. In addition, multiple elements may be merged into one element.

The functions of the first input unit 1301b, the second input unit 1302b, the first filter 1303b, the second filter 1304b, the third filter 1305b, the feature extraction unit 1306b, the classifier 1307b, and the predicted gesture label identification unit 1308b of the user equipment 1300b may be identical to those of the first input unit 1101, the second input unit 1102, the first filter 1103, the second filter 1104, the third filter 1105, the feature extraction unit 1106, the classifier 1107, and the predicted gesture label identification unit 1108 of the electronic device 1100 described in FIG. 11 above. Accordingly, as long as there is no mutual contradiction, to describe the corresponding element of FIG. 13, a description of the corresponding element of FIG. 11 may be referred to.

To describe the actual use procedure with reference to FIG. 13, the first input unit 1301b may identify, as input data (first input data). UWB data collected for a pre-specified gesture period. For example, in a case of the actual use procedure, the first input data may be real-time UWB data collected for the gesture period.

As an embodiment, the UWB data may include ranging data (ranging result data). AoA data, and/or CIR data. The ranging data, the AoA data, and the CIR data may be processed in parallel to one another, and may be input to the feature extraction unit 1306b or the classifier 1307b, as input data. For example, each of the ranging data, the AoA data, and the CIR data may be input as input data of the feature extraction unit 1306b or the classifier 1203b through individual processing of the first filter 1303b and the second filter 1304b. The processing of the first filter 1303b and the second filter 1304b of the user equipment 1300b for the corresponding input data is identical to the processing of the first filter 1203b and the second filter 1204b of the user equipment 1200b, and thus a redundant description is omitted.

The second input data collection unit 1302b may identify, as input data (second input data). IMU sensor data collected for the pre-specified gesture period. For example, in a case of the actual use procedure, the first input data may be real-time IMU sensor data collected for the gesture period. The gesture period for collection of the first input data by the first input data collection unit 1301b a may be identical to the gesture period for collection of the second input data by the second input data collection unit 1302b.

The IMU data may be input as input data of the classifier 1307b through the processing of the third filter 1305b. The processing of the third filter 1305b of the user equipment 1300b for the corresponding input data is identical to the processing of the third filter 1205b of the user equipment 1200b, and thus a redundant description is omitted.

The feature extraction unit 1306b may be used for optimal feature extraction to reduce data dimensionality and overfitting. The feature extraction unit 1306a may use principal component analysis (PCA) for optimal feature extraction.

The feature extraction unit 1306b may be applied to the first input data obtained through filtering by the second filter 1304b and the second input data obtained through filtering by the third filter 1305b. For example, the feature extraction unit 1306b may extract ranging data from which the outlier has been removed, AoA azimuth data from which the outlier has been removed, AoA elevation data from which the outlier has been removed, and IMU data to which the moving average filter is applied, so as to extract a feature (e.g., PCA-based feature).

As an embodiment, when the classifier 1307b is a convolutional neural network (CNN)-based classifier, the feature extraction unit 1306b may be omitted. For example, in a case of the CNN-based classifier, the extracted feature (e.g., PCA-based feature) is not required, and raw data (e.g., AoA data from which the outlier has been removed and IMU data to which the moving average filter is applied) can be directly used for gesture label prediction.

As an embodiment, when the classifier 1307b is a support vector machine (SVM)-based classifier, the feature extraction unit 1306a may be used. For example, in a case of the SVM-based classifier, the extracted feature (e.g., PCA-based feature) can be used for gesture label prediction.

The classifier 1307b may classify the input data into multiple output labels (e.g., gesture labels). The parameters for the classifier 1307b may be parameters determined through the initial fine-tuning procedure.

The input data of the classifier 1307b may be the first input data and the second input data to which the feature extraction unit 1306b is applied. For example, the input data of the classifier 1307b may include PCA-based feature data output from the feature extraction unit 1306b.

The input data of the classifier 1307b may be the first input data and the second input data to which the feature extraction unit 1306b is not applied. For example, the input data of the classifier 1307b may include ranging data from which the outlier has been removed. AoA azimuth data from which the outlier has been removed, AoA elevation data from which the outlier has been removed, and/or IMU data to which the moving average filter is applied.

As an embodiment, the classifier 1307b may classify the input data into two or more gesture labels (predicted gesture labels). For example, when the classifier 1307b is configured to have two gesture labels (e.g., two gesture labels corresponding to a boxing gesture and a circle gesture, respectively) as an output label, the classifier 1307b may output a probability that a probability that a gesture for the input data is a gesture (e.g., the boxing gesture) corresponding to a first gesture label and a probability that a gesture for the input data is a gesture (e.g., the circle gesture) corresponding to a second gesture label.

As an embodiment, the classifier 1307b may be a classifier using a machine learning algorithm. For example, the classifier 1307b may be an SVM-based classifier.

As an embodiment, the classifier 1307b may be a classifier using a deep learning algorithm. For example, the classifier 1307b may be a CNN-based classifier.

The predicted gesture label identification unit 1308b may identify output label data (predicted gesture label data) of the classifier 1307b, and may transfer the identified predicted gesture label data to the loss function unit 1307b. For example, when the classifier 1307b is configured to have two gesture labels (e.g., two gesture label corresponding to the boxing gesture and the circle gesture, respectively), as an output label, predicted gesture label data may include a probability that a gesture for the input data is a gesture (e.g., the boxing gesture) corresponding to a first gesture label and a probability that a gesture for the input data is a gesture (e.g., the circle gesture) corresponding to a second gesture label.

The user equipment 1200b may determine a final gesture by using the identified predicted gesture label data. For example, the user equipment 1200b may determine, as a final gesture, a gesture corresponding to a gesture label having the highest probability. Accordingly, in a case of the embodiment of FIG. 13, the user equipment 1300b may not include the ground truth gesture label identification unit and the loss function unit.

FIG. 14 illustrates a filtering operation of a first filter according to an embodiment of the disclosure.

The first filter of FIG. 14 may be a valid gesture identification filter, as an example of the first filter 1103 of FIG. 11, the first filter 1203a or 1203b of FIG. 12, and/or the first filter 1203a or 1203b of FIG. 13.

As an embodiment, a hyperparameter of the valid gesture identification filter may be a threshold.

In the embodiment of FIG. 14, the operation of the first filter may be understood as an operation of an electronic device (e.g., a remote server/user equipment) including the first filter.

Referring to FIG. 14, in operation 1410, a first filter (e.g., an electronic device) may identify, as input data to the first filter, UWB data (e.g., AoA data and/or CIR data) collected for a pre-specified gesture period.

In operation 1420, the first filter (or the electronic device) may calculate standard deviation of the input data. For example, when the input data is AoA data, the first filter may calculate standard deviation of AoA data collected fur the pre-specified gesture period. For example, when the input data is CIR data, the first filter may calculate standard deviation of CIR data collected for the pre-specified gesture period.

In operation 1430, the first filter (or the electronic device) may determine whether the standard deviation of the input data has a value equal to or greater than a threshold. For example, when the input data is AoA data, the first filter may determine whether the standard deviation of the AoA data has a value equal to or greater than a threshold. For example, when the input data is CIR data, the first filter may determine whether the standard deviation of the CIR data has a value equal to or greater than a threshold.

In operation 1440, when the standard deviation of the input data has a value smaller than the threshold, the first filter (or the electronic device) may identify that a valid gesture has been detected. In this case, the first filter may transfer the corresponding data to the next phase.

In operation 1450, when the standard deviation of the input data has a value smaller than the threshold, the first filter (or the electronic device) may identify that a random movement (e.g., random hand movement) has been detected. In this case, the first filter may discard the corresponding data.

FIG. 15 illustrates a filtering operation of a second filter according to an embodiment of the disclosure.

The second filter of FIG. 15 may be an outlier removal filter, as an example of the second filter 1104 of FIG. 11, the second filter 1204a or 1204b of FIG. 12, and/or the second filter 1204a or 1204b of FIG. 13.

As an embodiment, hyperparameters of the outlier removal filter may be window_left, window_right, and a threshold.

In the embodiment of FIG. 15, the operation of the second filter may be understood as an operation of an electronic device (e.g., a remote server/user equipment) including a second filter.

Referring to FIG. 15, in operation 1510, the second filter (e.g., the electronic device) may calculate a median of data points specified by window_left to the left and data points specified by window_right to the right, for each data point d. That is, a median of the data points within windows specified by window_left and window_right may be calculated.

In operation 1520, the second filter (or the electronic device) may determine whether a median (|d-median|) calculated for the corresponding data point d is equal to or greater than a threshold.

In operation 1530, when the median is equal to or greater than the threshold, the second filter (or the electronic device) may identify that an outlier has been detected. That is, it may be identified that the corresponding data point d is an outlier. In this case, the second filter may substitute the corresponding data point d for the corresponding median.

In operation 1540, when the median is smaller than the threshold, the second filter (or the electronic device) may identify that an outlier has not been detected. That is, it may be identified that the corresponding data point d is not an outlier. In this case, the second filter may not change data point d.

FIG. 16 illustrates a filtering operation of a third filter according to an embodiment of the disclosure.

The third filter of FIG. 16 may be a moving average filter, as an example of the third filter 1105 of FIG. 11, the third filter 1205a or 1205b of FIG. 12, and/or the third filter 1205a or 1205b of FIG. 13.

As an embodiment, a hyperparameter of the moving average filter may be window_length.

In the embodiment of FIG. 16, the operation of the third filter may be understood as an operation of an electronic device (e.g., a remote server/user equipment) including the third filter.

Referring to FIG. 16, each data point of IMU data may be substituted by a mean of data points of a number of previous time steps including the corresponding data point, the number being designated by window_length.

For example, as in FIG. 16, data point d0 may be substituted by d0′ corresponding to a mean 1620 of data points d0, d1, d2 and d3 having the length specified by window_length.

FIG. 17 illustrates an operation of a feature extraction unit according to an embodiment of the disclosure.

The feature extraction unit of FIG. 17 may be PCA, as an example of the feature extraction unit 1106 of FIG. 11, the feature extraction unit 1206a or 1206b of FIG. 12, and/or the feature extraction unit 1206a or 1206b of FIG. 13.

As an embodiment, a hyperparameter of the feature extraction unit may be num_components.

In the embodiment of FIG. 17, the operation of the feature extraction unit may be understood as an operation of an electronic device (e.g., a remote server/user equipment) including the feature extraction unit.

Referring to FIG. 17, in operation 1710, a feature extraction unit (or an electronic device) may identify, as an input, input data (e.g., CIR/AoA data and IMU data) to a pre-specified gesture period. This input may include an extremely high number of components.

In operation 1720, the feature extraction unit (or the electronic device) may extract the corresponding input as a number of PCA components, the number being specified by num_components. As an embodiment, the feature extraction unit may apply linear conversion of high-dimensional data from a current basis to another orthogonal basis (e.g., a smaller number (num_components) of components may represent the most (>=85%) of data variance). Through this, the dimensionality can be reduced.

FIG. 18 illustrates an operation of a classifier according to an embodiment of the disclosure.

A CNN-based classifier of FIG. 18 may be a CNN-based classifier (CNN classifier), as an example of the classifier 1109 of FIG. 11, the classifier 1209a or 1209b of FIG. 12, and/or the classifier 1209a or 1209b of FIG. 13.

In the embodiment of FIG. 18, the operation of the classifier may be understood as an operation of an electronic device (e.g., a remote server/user equipment) including a classifier.

The CNN classifier may use a deep learning algorithm to learn, with assistance of training data, to classify training input data into two or more output labels (e.g., gesture labels).

The CNN classifier can be efficient to extract spatial/temporal features from data. Accordingly, the CNN classifier may be suitable for extracting features for UWB ranging data and IMU data for a temporal gesture period.

As illustrated in FIG. 18, the CNN classifier may include a series of convolution layers (conv. layers) 1810 and pooling layers (e.g., maxpool layers) 1820.

FIG. 19 illustrates an operation of a loss function unit according to an embodiment of the disclosure.

The loss function unit of FIG. 19 may use a categorical cross entropy function as a loss function, as an example of the loss function unit 1110 of FIG. 11, the loss function unit 1210a or 1210b of FIG. 12, and/or the loss function unit 1210a or 1210b of FIG. 13.

In the embodiment of FIG. 19, the operation of the loss function unit may be understood as an operation of an electronic device (e.g., a remote server/user equipment) including the loss function unit.

Referring to FIG. 19, in operations 1910 and 1920, a loss function unit (or an electronic device) may identify, as an input to the loss function unit, a ground through gesture label and a predicted gesture label for the corresponding input data.

In operation 1930, the loss function unit (or the electronic device) may calculate a loss function based on a ground truth gesture label (ground truth value) and a predicted gesture label (predicted value).

In operation 1940, the loss function unit (or the electronic device) may update or fine-tune parameters for a classifier (e.g., an SVM classifier/CNN classifier) by using backpropagation of the calculated loss function (backpropagation of gradients).

As an embodiment, in a case of the user equipment, the loss function unit may be activated only when an initial fine-tuning procedure for a new user is performed. In this case, for the initial fine-tuning procedure for the corresponding user, for a pre-specified initial fine-tuning period, a user may perform a specified gesture one time according to an instruction by an application, and tuning data (e.g., UWB data and IMU data) acquired for this period may be used in the initial fine-tuning procedure. In the initial fine-tuning procedure, a gesture label predicted from the tuning data may be compared with a ground truth gesture label by using a pretrained model. In this case, the user equipment may calculate a loss function by using a result of the comparison, and may fine-tune a classifier (e.g., SVM classifier/CNN classifier) for the corresponding user by backpropagating the loss function.

As an embodiment, in a case of the remote server, the loss function may be used perform a training procedure for a mode (classifier) or may be used to perform an initial fine-tuning procedure for a new user of the trained model.

In the training procedure, a gesture label predicted from training data may be compared with a ground truth gesture label by using a model in training. In this case, the remote server may calculate a loss function by using a result of the comparison, and may train a classifier (e.g., SVN classifier/CNN classifier) for the corresponding user by backpropagating the loss function.

In the initial fine-tuning procedure, a gesture label predicted from the tuning data may be compared with a ground truth gesture label by using a model pretrained through a training procedure. In this case, the remote server may calculate the loss function by using a result of the comparison, and may fine-tune a classifier (e.g., SVM classifier/CNN classifier) for the corresponding user by backpropagating the loss function. The tuning data may be collected by the user equipment, as in the above-described method, and transferred to the remote server. A parameter for the adjusted classifier may downloaded again by the user equipment.

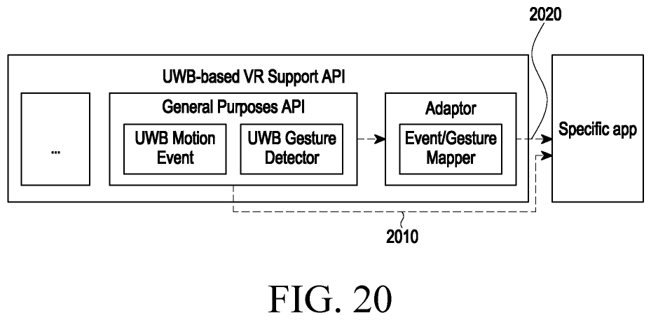

FIG. 20 illustrates a method in which an electronic device transfers a gesture detection result to an application, as an input, according to an embodiment of the disclosure.

Referring to FIG. 20, a method in which an electronic device transfers a gesture detection result to an application, as an input (e.g., a UX input), may differ according to two modes below.

A first mode may be a general mode, and a second mode may be an application-specific mode (e.g., a game application-specific mode).

According to each mode, a required component (e.g., a software component) may differ.

In a case of the first mode, for example, similar to a touch-based motion event (MotionEvent) and gesture detector (GestureDetector) classes (or APIs) in the Android API, a UWB-based gesture detector API may be newly defined as a general purpose API. For example, as illustrated in FIG. 20, a UWB-based gesture detector API (UWB gesture detector) may be newly defined in a general purpose API in a UWB-based VR support API. In this case, the electronic device may directly provide, based on the UWB-based gesture detector API, the application with the gesture detection result as a UX input. (operation 2010).

In a case of the second mode, an adaptor API for mapping the gesture detection result and pre-defined features of a specific application. For example, as illustrated in FIG. 20, an adaptor API (event/gesture mapper) for a specific application rather than general purposes API may be defined within the UWB-based VR support API. In this case, the electronic device may map, based on the adaptor API, the gesture detection result and the pre-defined feature of the corresponding application, and transfer the same to the corresponding application, as a UX input (operation 2020).

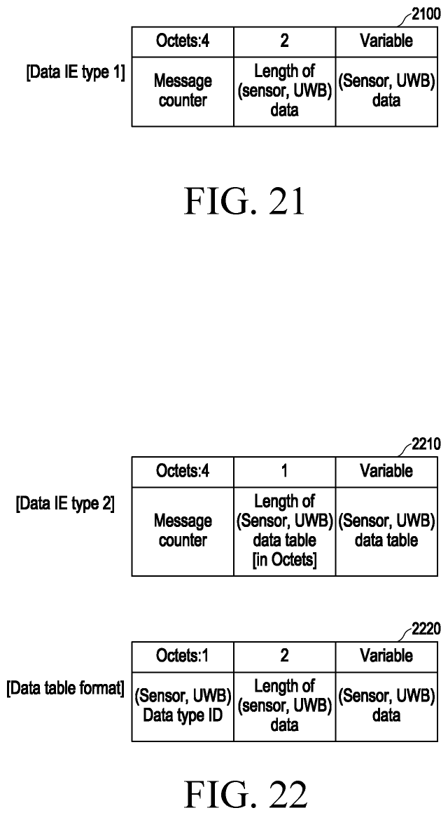

FIG. 21 illustrates an example of a data information element according to an embodiment of the disclosure.

A data information element (IE) 2100 of FIG. 21 may be an IE used when, for example, one electronic device in a BAN transfers UWB data acquired by the electronic device itself and/or sensor data to another electronic device. For example, the data IE 2100 may be used when a peripheral device transfers UWB data (e.g., ranging data, AoA data, and CIR data) acquired by the peripheral device itself and/or sensor data (e.g., IMU sensor data) to a VR device. Alternatively, the data IE 2100 may be used when a VR device transfers UWB data (e.g., ranging data, AoA data, and CIR data) acquired by the VR device itself and/or sensor data (e.g., IMU sensor data) to a peripheral device.

Referring to FIG. 21, the data IE 2100 may include a message counter field, a data length field, and/or a data field. In the disclosure, the data IE of FIG. 21 may be referred to as data IE type 1.

The message counter field may indicate a value of a message counter.

The data length field may be used to indicate the length of a data field.

The data field may include data (e.g., UWB data and/or sensor data) to be transferred.

As an embodiment, the data IE 2100 may be transferred through UWB in-band communication. For example, the data IE may be piggy-backed on a UWB ranging message and transferred. For example, the data IE may be included as an application payload of a UWB TWR message (e.g., RRM or FM). That is, the UWB TWR message may include the data IE as one of payload IEs.

As an embodiment, the data IE 2100 may be transferred through UWB out-of-band communication. For example, the data IE may be transferred through other communication (e.g., Wi-Fi-based communication) to support low latency in UWB communication.

FIG. 22 illustrates another example of a data information element according to an embodiment of the disclosure.

A data information element (IE) 2210 of FIG. 22 may be an IE used when, for example, one electronic device in a BAN transfers UWB data acquired by the electronic device by itself and/or sensor data to another electronic device. For example, the data IE 2210 may be used when a peripheral device transfers UWB data (e.g., ranging data, AoA data, and CIR data) acquired by the peripheral device itself and/or sensor data (e.g., IMU sensor data) to a VR device.

Referring to FIG. 22, the data IE 2210 may include a message counter field, a data table length field, and/or at least one data table filed 2220. In the disclosure, the data IE of FIG. 21 may be referred to as data IE type 2.

Unlike the data IE of FIG. 21, the data IE 2210 of FIG. 22 may configure a separate table for each data type.

The message counter field may indicate a value of a message counter.

The data length field may be used to indicate the length (or number) of the data table fields.

As an embodiment, the data IE may include as many data table field as the number (or the length) specified by the data length field.

Each data table field 2220 may include a data type ID field, a data length field, and a data field.

The data type ID field may include an identifier indicating the type of data transferred through a corresponding data table field. Whether data included in the corresponding data table field is sensor data (second type) or UWB data (first type) may be identified according to the value of the data type ID field.

The data length field may be used to indicate the length of the data field.

The data field may include data (e.g., UWB data and/or sensor data) to be transferred. The data field may include data having a data type identified by the data type ID field.

As an embodiment, the data IE 2210 may be transferred through UWB in-band communication. For example, the data IE may be piggy-backed on a UWB ranging message and transferred. For example, the data IE may be included as an application payload of a UWB TWR message (e.g., RRM). That is, the UWB TWR message may include the data IE as one of payload IEs.

As an embodiment, the data IE 2210 may be transferred through UWB out-of-band communication. For example, the data IE may be transferred through other communication (e.g., Wi-Fi-based communication) to support low latency in UWB communication.

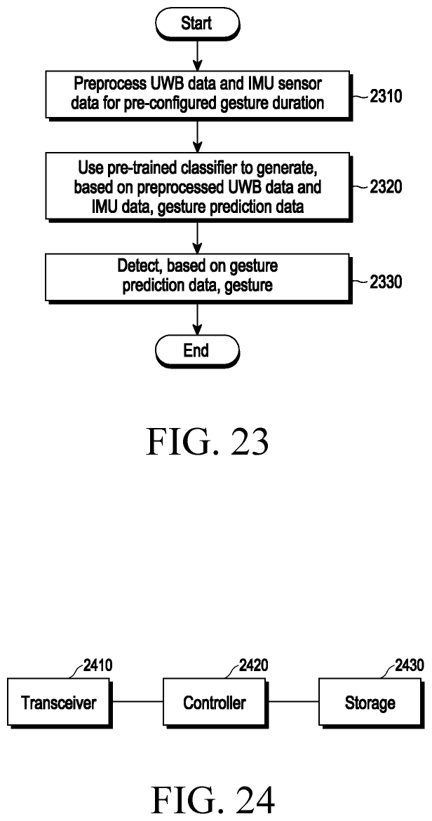

FIG. 23 is a flowchart illustrating a method for an electronic device according to an embodiment of the disclosure.

An electronic device of FIG. 23 may be, for example, a VR device (e.g., the VR device 710, 810, 1100, 1200b, or 1300b).

Referring to FIG. 23, the electronic device may pre-process UWB data and IMU sensor data for a pre-specified gesture period (operation 2310).

The electronic device may generate gesture prediction data (predicted gesture label data) based on the pre-processed UWB data and the pre-processed IMU data by using a pretrained classifier (operation 2320).

The electronic device may detect a gesture based on the gesture prediction data (operation 2330).

As an embodiment, the electronic device may filter the UWB data by using at least one first filter and filter the IMU sensor data by using a second filter in order to perform preprocessing.

As an embodiment, the UWB data may include at least one of ranging result data, angle of arrival (AoA) data, or channel impulse response (CIR) data, acquired through UWB ranging between the electronic device and at least one peripheral device.

As an embodiment, the pretrained classifier may be a support vector machine (SVM)-based classifier or a convolutional neural network (CNN)-based classifier.

As an embodiment, when the pretrained classifier is the SVM-based classifier, the electronic device may acquire PCA feature data based on the preprocessed UWB data and the preprocessed IMU data by using a PCA algorithm, and generate the gesture prediction data based on the PCA feature data by using the SVM-based classifier.

As an embodiment, the UWB ranging may correspond to UWB two-way ranging (TWR), the electronic device may perform the role of a controller or an initiator for the UWB TWR, and the at least one peripheral device may perform the role of a controlee or a responder for the UWB TWR.

As an embodiment, the at least one peripheral device may transmit, to the electronic device, a data information element including UWB data acquired through the UWB TWR and IMU sensor data acquired by an IMU sensor of the corresponding peripheral device.

As an embodiment, the data information element may be included in a ranging response message for the UWB TWR and transmitted.

As an embodiment, the data information element may include a length field specifying the length of a data field, and a data field including at least one of the UWB data and the IMU sensor data.

As an embodiment, the data information element may include a length field specifying the number of data table fields and as many data table fields as the number specified by the length field, each data table field may include a data type ID field specifying a data type included in a data field, a length field specifying the length of the data field, and a data field including data having a data type specified by the data type ID field, and the data type may be one of a first type specifying the UWB data and a second type specifying the IMU sensor data.

As an embodiment, the at least one first filter may be include a valid gesture identification filter using standard deviation of data to distinguish between a valid restore and a random gesture and an outlier removal filter for removing outliers by using a median of surrounding values, and the outlier removal filter may be applied after the valid gesture identification filter.

As an embodiment, the second filter may be a moving average filter, and the moving average filter may substitute each data point for a median of as many data points as the number specified by a pre-specified window length.

As an embodiment, in a case of an initial fine-tuning period, the electronic device may calculate a loss function by comparing the predicted data with the actual data, and may adjust parameters of the pretrained classifier by backpropagating the loss function.

FIG. 24 illustrates a structure of an electronic device according to an embodiment of the disclosure.

In the embodiment of FIG. 24, the electronic device may be a VR device or a peripheral device.

Referring to FIG. 24, the electronic device may include a transceiver 2410, a controller 2420, and a storage 2430. In the disclosure, the controller may be defined as a circuit, an application-specific integrated circuit, or at least one processor.

The transceiver 2410 may transmit or receive a signal to or from another electronic device.

The controller 2420 may control the overall operation of the electronic device according to the embodiment proposed in the disclosure. For example, the controller 2420 may control a signal flow between blocks to perform the operations according to the above-described flowchart. Specifically, the controller 2420 may control, for example, the operation of the electronic device, described with reference to FIGS. 1 to 23.

The storage 2430 may store at least one of information transmitted or received through the transceiver 2410 and information generated through the controller 2420. For example, the storage 2430 may store information and data required for positioning described with reference to FIGS. 1 to 23.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method for an electronic device, the method comprising:
preprocessing ultrawideband (UWB) data and inertial measurement unit (IMU) sensor data for a pre-specified gesture period;
generating gesture prediction data, based on the preprocessed UWB data and IMU data, by using a pretrained classifier; and
detecting a gesture, based on the gesture prediction data,
wherein the preprocessing comprises filtering the UWB data by using at least one first filter, and filtering the IMU sensor data by using a second filter, and
wherein the UWB data comprises at least one of ranging result data, angle of arrival (AoA) data, or channel impulse response (CIR) data acquired through UWB ranging between the electronic device and at least one peripheral device.

2. The method of claim 1, wherein the pretrained classifier is a support vector machine (SVM)-based classifier or a convolutional neural network (CNN)-based classifier.

3. The method of claim 2, wherein in case that the pretrained classifier is the SVM-based classifier, the generating of the gesture prediction data comprises:
acquiring PCA feature data, based on the preprocessed UWB data and the preprocessed IMU data, by using a principal component analysis (PCA) algorithm; and
generating the gesture prediction data, based on the PCA feature data, by using the SVM-based classifier.

4. The method of claim 1, wherein the UWB ranging is UWB two way ranging (TWR),
wherein the electronic device is configured to serve as a controller and an initiator for the UWB TWR, and
wherein the at least one peripheral device is configured to serve as a controlee and a responder for the UWB TWR.

5. The method of claim 4, wherein the at least one peripheral device is configured to transmit, to the electronic device, a data information element comprising at least one of the UWB data acquired through the UWB TWR and the IMU sensor data acquired by an IMU sensor of the corresponding peripheral device.

6. The method of claim 5, wherein the data information element is included in a ranging response message for the UWB TWR and transmitted through the ranging response message.

7. The method of claim 5, wherein the data information element comprises a length field specifying a length of a data field, and a data field comprising at least one of the UWB data and the IMU sensor data.

8. The method of claim 5, wherein the data information element comprises a length field specifying the number of data table fields and data table fields of the number specified by the length field,
wherein each data table field comprises a data type ID field specifying a data type included in a data field, a length field specifying a length of the data field, and a data field comprising data having the data type specified by the data type ID field, and
wherein the data type is one of a first type specifying the UWB data or a second type specifying the IMU sensor data.

9. The method of claim 1, wherein the at least one first filter comprises a valid gesture identification filter using a standard deviation of data to distinguish between a valid gesture and a random gesture, and an outlier removal filter for removing outliers by using a median of surrounding values, and
wherein the outlier removal filter is applied after the valid gesture identification filter.

10. The method of claim 1, wherein the second filter is a moving average filter, and
wherein the moving average filter causes each data point to be substituted by a median of as many data points as a number determined by a pre-specified window length.

11. The method of claim 1, further comprising, in case of an initial fine-tuning period:
comparing an error between the prediction data and actual data to calculate a loss function; and
backpropagating the loss function to adjust parameters of the pretrained classifier.

12. An electronic device comprising:
a transceiver; and
a controller connected to the transceiver,
wherein the controller is configured to:
preprocess ultrawideband (UWB) data and inertial measurement unit (IMU) sensor data for a pre-specified gesture period;
generate gesture prediction data, based on the preprocessed UWB data and IMU data, by using a pretrained classifier; and
detect a gesture, based on the gesture prediction data,
wherein the controller is further configured to, for the preprocessing, filter the UWB data by using at least one first filter, and filter the IMU sensor data by using a second filter, and
wherein the UWB data comprises at least one of ranging result data, angle of arrival (AoA) data, or channel impulse response (CIR) data acquired through UWB ranging between the electronic device and at least one peripheral device.

13. The electronic device of claim 12, wherein the pretrained classifier is a support vector machine (SVM)-based classifier or a convolutional neural network (CNN)-based classifier.

14. The electronic device of claim 13, wherein in case that the pretrained classifier is the SVM-based classifier, the controller is configured to:
acquire PCA feature data, based on the preprocessed UWB data and the preprocessed IMU data, by using a principal component analysis (PCA) algorithm; and
generate the gesture prediction data, based on the PCA feature data, by using the SVM-based classifier.

15. The electronic device of claim 12, wherein the UWB ranging is UWB two way ranging (TWR),
wherein the electronic device is configured to serve as a controller and an initiator for the UWB TWR, and
wherein the at least one peripheral device is configured to serve as a controlee and a responder for the UWB TWR.
